(19) United States
(12) Patent Application Publication
(10) Pub. No.: US 2009/0215192 A1
(43) Pub. Date: Aug. 27, 2009

(54) Solid-phase affinity-based method for preparing and manipulating an analyte-containing solution

(75) Inventors: Mark L. Stolowitz, Pleasanton, CA (US); Allan H. Stephan, Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Stratos Biosystems, LLC, Seattle, WA (US)

(21) Appl. No.: 11/569,096

(22) PCT Filed: May 26, 2005
(86) PCT No.: PCT/US05/18687

§ 371 Date: Jul. 24, 2008

Related U.S. Application Data
(60) Provisional application No. 60/575,220, filed on May 27, 2004.

(51) Int. Cl. G01N 1/00; B05D 3/00; B01J 19/00; B01D 57/02

(52) U.S. Cl. 436/174; 427/2.13; 422/68.1; 204/450; 205/687

(57) ABSTRACT

A method for preparing an analyte-containing solution, which is compatible with surface-tension-directed liquid droplet manipulation and solid-phase affinity-based assays, is disclosed. The method comprises providing an affinity capture surface comprising a substrate surface having a plurality of first and second surface modifiers associated therewith, wherein the first and second surface modifiers render the affinity capture surface wettable and resistant to non-specific protein adsorption, and wherein the second surface modifiers are capable of selectively retaining an analyte, contacting the affinity capture surface with the analyte to form analyte/surface modifier complexes between the analyte and the second surface modifiers, and cleaving the first and second surface modifiers to release terminal portions of the first and second surface modifiers and the analyte into a solution in contact with the affinity capture surface, thereby yielding the analyte-containing solution and generating a hydrophobic surface. Novel affinity capture surfaces and methods for preparing the same are also disclosed.

### BACKGROUND OF THE INVENTION

1. Field of the Invention

This invention relates generally to a solid-phase affinity-based method for preparing and manipulating an analyte-containing solution which is compatible with surface-tension-directed liquid droplet manipulation.

2. Description of the Related Art

Liquid droplet motion can be initiated and self-propelled by a surface energy gradient on a substrate. Aqueous droplets move from regions of low surface energy (hydrophobic) to regions of high surface energy (hydrophilic). Historically, surface gradients were generated either passively using patterned surfaces with spatial variations in surface energy (see, e.g., Chaudhury, M. K. and Whitesides, G. M., Nature (1992), 256, 1539; and Daniel, S.; Chaudhury, M. K. and Chen, J. C., Science (2001) 291, 633) or actively using surfactant-like agents that adsorb onto the contacted surface and induce localized changes in wettability (see, e.g., Bain, C. D., Burnett-Hall, G. D. and Montgomerie, R. R., Nature (1994) 372, 414; Domingues Dos Santos, F. and Ondarcuhu, T., Phys. Rev. Lett. (1995) 75(16), 2972; Ichimura, K. and Oh, S.-K., Science (2000) 288, 1624; and Lee, S.-W. and Laibinis, P. E., J. Amer. Chem. Soc. (2000) 122, 5395). Besides the obvious importance of surface tension and wettability in understanding interfacial phenomena, the practical control of wettability is essential in the design and operation of microfluidic devices. Current methods exploited to control the flow of droplets through microfluidic devices rely either upon electrokinetic phenomena requiring high voltages, mechanical actuators and syringes, or capillary wetting. Improvements in nonmechanical means to pump and position droplets can be expected to positively impact emerging microfluidic technologies by significantly reducing the complexity and cost of individual microfluidic devices.

The self-propelled motion of a liquid droplet due to a surface energy gradient (contact angle hysteresis) is termed surface-tension-directed liquid droplet manipulation.

A lab-on-a-chip device that utilizes surface-tension-directed liquid droplet manipulation in conjunction with thermal Marangoni pumping is disclosed in U.S. Patent Application No. 2002/0031835, published Mar. 14, 2002, which is incorporated herein by reference in its entirety.

One particularly attractive approach to surface-tension-directed liquid droplet manipulation exploits the principal of electrowetting-on-dielectric (see, e.g., Washizu, M., IEEE Transactions on Industry Applications (1998) 34(4), 732-737; Pollack, M. G., Fair, R. B. and Shenderov, A. D., Applied Physics Letters (2000) 77(11), 1725-1726; and Lee, J., Moon, H., Fowler, J., Schoellhammer, T. and Kim, C.-J., Sensors and Actuators A (2002) 95, 259-268). In electrowetting-on-dielectric, a droplet rests on a surface or in a channel coated with a hydrophobic material. The surface is modified from hydrophobic to hydrophilic by applying a voltage between the liquid droplet and an electrode residing under a hydrophobic dielectric surface layer. Charge accumulates at the liquid-solid interface, leading to an increase in surface wettability and a concomitant decrease in the liquid-solid contact angle. By changing the wettability of each of the electrodes patterned on a substrate, liquid drops can be shaped and driven along a series of adjacent electrodes, making microscale liquid handling extremely simple both with respect to device fabrication and operation. Several unit operations involving creating, transporting, cutting, and merging liquid droplets by electrowetting-based actuation have been demonstrated (Cho, S. K., Moon, H. and Kim, C.-J., J. Microelectromechanical Systems (2003) 12(1), 70-80). Very recently, methods for the minimization of biomolecular adsorption during surface-tension-directed liquid droplet manipulation of protein-containing solutions were described (Jeong-Yeol, Y. and Garrell, R. L., Anal. Chem. (2003) 75: 5097-5102).

Electrowetting-on-dielectric (EWOD) offers the following advantages over alternative microfluidic approaches: (1) EWOD does not require that soluble or particulate analytes be charged or have large polarizabilities; (2) the power required to transport liquid droplets is much lower than in micropumping or electrophoresis-based devices; (3) EWOD-based devices require no moving parts; and (4) EWOD-based devices can be reconfigured simply by reprogramming the sequence of applied potentials. Furthermore, because the liquid is not in direct contact with the electrodes, electrolysis and analyte oxidation-reduction reactions are avoided.

Exemplary electrowetting-on-dielectric devices for liquid droplet manipulation are disclosed in U.S. Pat. No. 6,565,727, issued May 20, 2003; U.S. patent application Ser. No. 09/943,675, published Apr. 18, 2002; U.S. patent application Ser. No. 10/305,429, published Sep. 4, 2003; U.S. patent application Ser. No. 10/343,261, published Nov. 6, 2003; U.S. Patent Application No. 2004/0031688 A1, published Feb. 19, 2004; U.S. Patent Application No. 2004/0058450 A1, published Mar. 25, 2004; U.S. Patent Application No. 2004/0055536 A1, published Mar. 25, 2004; and U.S. Patent Application No. 2004/0055891, published Mar. 25, 2004; all of which are incorporated herein by reference in their entirety.

Recently, the design of surfaces that can alter the display of ligands, and hence interactions of proteins and cells has attracted considerable interest (see, e.g., Yeo, W.-S.; Yousaf, M. N. and Mrksich, M., J. Am. Chem. Soc. (2003) 125, 14994-14995; Yousaf, M. N.; Houseman, B. T. and Mrksich, M., PNAS (2001) 98(11), 5992-5996; Yeo, W.-S.; Hodneland, C. D. and Mrksich, M., ChemBioChem (2001) (8), 590-593; Hodneland, C. D. and Mrksich, M., J. Am. Chem. Soc. (2000) 122, 4235-4236; and Hodneland, C. D. and Mrksich, M., Langmuir (1997) 13(23), 6001-6003). Applications that require precise control with respect to the display of ligands have benefited from the use of self-assembled monolayers (SAMs) comprised of alkanethiolates on gold because these well-ordered films offer extraordinary flexibility in modifying surfaces with ligands and other moieties. Potential-assisted deposition of SAMs (see, e.g., Ma, F. and Lennox, R. B., Langmuir (2000) 16, 6188-6190; Wang, J., Jiang, M., Kawde, A. M. and Polsky, R., Langmuir (2000) 16, 9687-9689; and Mirsky, V. M., Trends in Analytical Chemistry (2002) 21, 439-450) provides a methodology for the rapid and reproducible manufacture of binary SAMs having fixed ratios of affinity capture and background monomers.

SAMs have been used to prepare monolayers that are inert with respect to biological fluids—in that they prevent protein adsorption and cell adhesion (see, e.g., Mrksich, M. and Whitesides, G. M., Am. Chem. Soc. Symp. Ser. Chem. Biol. Appl. Polyethylene Glycol (1997) 680, 361-373; Otsuni, E.; Yan, L. and Whitesides, G. M., Colloids and Surfaces B, Biointerfaces (1999) 15, 3-30; and Chapman, R. G.; Ostuni, E.; Takayama, S,; Holmlin, R. E.; Yan, L. and Whitesides, G. M., J. Am. Chem. Soc. (2000) 122, 8303-8304). The attachment of ligands to such inert SAMs affords surfaces to which proteins and other receptors selectively bind.

Furthermore, surfaces comprised of SAMs that release immobilized ligands under electrochemical control are disclosed in U.S. patent application Ser. No. 09/797,166, published Aug. 29, 2002, which is incorporated herein by reference in its entirety. SAMs that release immobilized ligands may be exploited to recover targeted cells or proteins.

However, a significant limitation associated with surface-tension-directed liquid droplet manipulation is the fact that popular solid-phase affinity-based assays, which exploit surfaces having immobilized biological ligands, are generally incompatible with this approach. This limitation results from the combination of the inherent wettability associated with surfaces having immobilized biological ligands and the inefficiency of surface-tension-directed liquid droplet manipulation involving adjacent sites which can not be significantly differentiated on the basis of surface energy. Generally speaking, contact angle differences of greater than 30° between adjacent sites are required to initiate surface-tension-directed self-propelled liquid droplet movement. For example, electrowetting-on-dielectric usually results in a contact angle reduction of from greater than about 110° to less than about 70°. Unfortunately, surfaces comprised of SAMs having immobilized biological ligands usually exhibit contact angles in the range of about 10° to about 40°. Consequently, electrowetting-on-dielectric facilitated liquid droplet movement from a site having an immobilized biological ligand to an adjacent electrowettable site either does not proceed or proceeds with limited efficiency.

Accordingly, although there have been advances in the field, there remains a need for methods whereby an analyte-containing solution can be prepared from a surface having immobilized biological ligands under conditions which render the analyte-containing solution compatible with surface-tension-directed liquid droplet manipulation. The present invention addresses these needs and provides further related advantages.

### BRIEF SUMMARY OF THE INVENTION

In brief, the present invention relates to a solid-phase affinity-based method for preparing an analyte-containing solution which is compatible with surface-tension-directed liquid droplet manipulation.

In a first embodiment, the present invention provides a method for preparing an analyte-containing solution comprising the steps of: (1) providing an affinity capture surface comprising a substrate surface having a plurality of first and second surface modifiers associated therewith, wherein the first and second surface modifiers render the affinity capture surface wettable and resistant to non-specific protein adsorption, and wherein the second surface modifiers are capable of selectively retaining an analyte; (2) contacting the affinity capture surface with the analyte to form analyte/surface modifier complexes between the analyte and the second surface modifiers; and (3) cleaving the first and second surface modifiers to release terminal portions of the first and second surface modifiers and the analyte into a solution in contact with the affinity capture surface, thereby yielding the analyte-containing solution and generating a hydrophobic surface.

In further embodiments, the analyte-containing solution is an analyte-containing liquid droplet and the method further comprises the step of transferring the analyte-containing liquid droplet to an adjacent transfer surface by surface-tension-directed liquid droplet manipulation or electrowetting-on-dielectric liquid droplet manipulation. The adjacent transfer surface may be separated from, or contiguous with, the affinity capture surface. In addition, the adjacent transfer surface may be partially or completely surrounded by the affinity capture surface.

In yet further embodiments, the first surface modifiers have the structure:

-A-L-X-Y₁;

and the second surface modifiers have the structure:

-A-L-X-Y₂-Z,

wherein each A is a terminal anchoring moiety associated with the substrate surface, L is a linker moiety, X is a cleavable moiety, Y₁ and Y₂ are protein adsorption resistant moieties and Z is an affinity capture moiety.

In more specific embodiments of the foregoing:
A is —S—;
L is —(CH₂)ₘ—;
X is

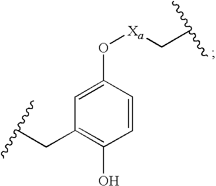

Y₁ is —(OCH₂CH₂)ₙOY₁ₐ;
Y₂ is —(OCH₂CH₂)ₚ—;
Xₐ is —C(═O)—, —C(═O)O—, —C(═O)NH—, —C(═O)S—, —SO₂—, —Si(CH₃)₂—, —Si(CH₂CH₃)₂—, —Si(CH(CH₃)₂), —CH₂CH═CH— or —CH₂C₆H₄—;
Y₁ₐ is —H or —CH₃;
m is an integer from 2 to 16;
n is an integer from 3 to 7; and
p is an integer from 5 to 9.

In yet further more specific embodiments, Xₐ is —C(═O)—, Y₁ₐ is —H, m is an integer from 4 to 10, n is 3 or 4, and p is an integer from 5 to 9.

In a second embodiment, the present invention provides an affinity capture surface comprising a substrate surface having a plurality of first and second surface modifiers associated therewith, wherein the first and second surface modifiers render the affinity capture surface wettable and resistant to non-specific protein adsorption, and the second surface modifiers are capable of selectively retaining an analyte. In addition, the first surface modifiers have the structure:

-A-L-X-Y₁;

and the second surface modifiers have the structure:

-A-L-X-Y₂-Z,

wherein each A is a terminal anchoring moiety associated with the substrate surface, L is a linker moiety, X is a cleavable moiety, Y₁ and Y₂ are protein adsorption resistant moieties and Z is an affinity capture moiety.

In more specific embodiments of the foregoing:
A is —S—;
L is —(CH₂)ₘ—;
X is

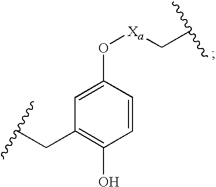

Y₁ is —(OCH₂CH₂)ₙOY₁ₐ;
Y₂ is —(OCH₂CH₂)ₚ—;
Xₐ is —C(═O)—, —C(═O)O—, —C(═O)NH—, —C(═O)S—, —SO₂—, —Si(CH₃)₂—, —Si(CH₂CH₃)₂—, —Si(CH(CH₃)₂—, —CH₂CH═CH— or —CH₂C₆H₄—;
Y₁ₐ is —H or —CH₃;
m is an integer from 2 to 16;
n is an integer from 3 to 7; and
p is an integer from 5 to 9.

In yet further more specific embodiments, Xₐ is —C(═O)—, Y₁ₐ is —H, m is an integer from 4 to 10, n is 3 or 4, and p is an integer from 5 to 9.

In a third embodiment, the present invention provides a method for preparing the foregoing affinity capture surface, wherein A is —S—, the method comprising contacting the substrate surface with a plurality of first and second thiols, wherein the first thiols have the structure:

HS-L-X-Y₁;

and the second thiols have the structure:

HS-L-X-Y₂-Z.

In further embodiments, the substrate surface comprises a metal, such as gold, and the method further comprises applying a positive potential to the substrate surface while contacting the substrate surface with the plurality of first and second thiols.

In a fourth embodiment, the present invention provides a method for preparing the foregoing affinity capture surface, wherein A is —S—, the method comprising contacting the substrate surface with a plurality of first and second disulfides wherein the first disulfides have the structure:

Y₁-X-L-S—S-L-X-Y₁;

and the second disulfides have the structure:

Z-Y₁-X-L-S—S-L-X-Y₁-Z.

In further embodiments, the substrate surface comprises a metal, such as gold, and the method further comprises applying a positive potential to the substrate surface while contacting the substrate surface with the plurality of first and second disulfides.

In a fifth embodiment, the present invention provides a sample presentation device comprising the foregoing affinity capture surface and an adjacent surface-tension-directed transfer surface.

In a sixth embodiment, the present invention provides a sample presentation device comprising the foregoing affinity capture surface and an adjacent electrowetting-on-dielectric transfer surface.

In the foregoing fifth and sixth embodiments, the adjacent transfer surface (i.e., the surface-tension-directed transfer surface or the electrowetting-on-dielectric transfer surface) may be separated from, or contiguous with, the affinity capture surface. In addition, the adjacent transfer surface may be partially or completely surrounded by the affinity capture surface.

These and other aspects of the invention will be apparent upon reference to the attached figures and following detailed description.

### BRIEF DESCRIPTION OF THE DRAWINGS

FIGS. 1a and 1b illustrate the preparation of an affinity capture surface by deposition of a binary self-assembled monolayer comprised of affinity capture surface modifiers and background surface modifiers.

FIGS. 2a, 2b and 2c illustrate the process whereby the affinity capture surface is contacted with a solution containing an analyte to form analyte/surface modifier complexes between the analyte and the affinity capture surface modifiers.

FIGS. 3a and 3b illustrate the cleavage of the affinity capture and background surface modifiers to yield both an analyte-containing solution, wherein the analyte and the terminal portion of the affinity capture surface modifier remain associated, and a hydrophobic surface, which is not wetted by the analyte-containing solution.

FIGS. 4a and 4b illustrate the cleavage of the affinity capture and background surface modifiers to yield both an analyte-containing solution, wherein the analyte and terminal portion of the affinity capture surface modifier do not remain associated, and a hydrophobic surface, which is not wetted by the analyte-containing solution.

FIGS. 5a and 5b illustrate the preparation of an affinity capture surface by potential-assisted deposition of a binary self-assembled monolayer comprised of affinity capture surface modifiers and background surface modifiers.

FIGS. 6a, 6b, 6c and 6d illustrate the preparation of an affinity capture surface and an adjacent surface-tension-directed transfer surface by potential-assisted deposition of a first self-assembled monolayer followed by potential-assisted deposition of a second self-assembled monolayer.

FIGS. 7a and 7b illustrate the electrochemical cleavage of affinity capture and background surface modifiers to yield an analyte-containing solution on a hydrophobic surface which is not wetted by the analyte-containing solution.

FIG. 8 depicts a representative affinity capture surface comprised of affinity capture surface modifiers and background surface modifiers.

FIG. 9 depicts a representative analyte-containing solution prepared by electrochemical cleavage of the affinity capture and background surface modifiers of FIG. 8.

FIG. 10 shows the general synthetic scheme for the preparation of representative affinity capture surface modifiers and background surface modifiers.

FIGS. 11a, 11b and 11c depicts a representative sample presentation device having adjacent, and separate, affinity capture and surface-tension-directed transfer surfaces.

FIGS. 12a, 12b and 12c illustrate the operation of the sample presentation device of FIGS. 11a, 11b and 11c.

FIGS. 13a, 13b and 13c depict a representative sample presentation device having adjacent, and contiguous, affinity capture and surface-tension-directed transfer surfaces.

FIGS. 14a, 14b and 14c illustrate the operation of the sample presentation device of FIGS. 13a, 13b and 13c.

FIGS. 15a, 15b and 15c depict a representative sample presentation device having adjacent affinity capture and electrowetting-on-dielectric transfer surfaces.

FIGS. 16a, 16b and 16c illustrate the operation of the sample presentation device of FIGS. 15a, 15b and 15c.

FIGS. 17a, 17b and 17c depict a representative sample presentation device having adjacent affinity capture and electrowetting-on-dielectric transfer surfaces, which share a common metallic thin film.

FIGS. 18a, 18b and 18c illustrate the operation of the sample presentation device of FIGS. 17a, 17b and 17c.

FIGS. 19a through 19f illustrate the preparation of a representative sample presentation device.

FIGS. 20a through 20f illustrate the operation of the sample presentation device depicted in FIGS. 19a through 19f.

FIG. 21 shows the synthetic scheme for the preparation of a representative first thiol.

FIG. 22 shows the synthetic scheme for the preparation of a representative second thiol.

### DETAILED DESCRIPTION OF THE INVENTION

As noted above, the present invention generally relates to a method for preparing an analyte-containing solution which is compatible with both surface-tension-directed liquid droplet manipulation, which is initiated on a surface exhibiting hydrophobic properties, and solid-phase affinity-based assays exploiting immobilized biological ligands, which occur on a surface exhibiting hydrophilic properties.

### DEFINITIONS

As used herein, the following terms have the meanings set forth below:

“Adsorption” refers to the process by which an analyte is retained on a surface as a consequence of interactions, such as chemical bonding (covalent or non-covalent), between the analyte and the surface.

“Analyte” refers to one or more components of a sample which are desirably detected. Examples of representative analytes are set forth in more detail below.

“Sample presentation device” refers to a device that is insertable into and removable from an analytical instrument and comprises a substrate having a surface for presenting analytes for detection.

“Surface” refers to the exterior, interior passage or boundary of a body or substrate.

“Surface tension” refers to a property of liquids in which a liquid droplet deposited on a surface tends to contact the smallest possible contact area because of unequal molecular cohesive forces near the surface, measured by the force per unit of length.

“Wettability” refers to the degree to which a solid surface is wetted by a liquid. With respect to water, high-energy surfaces are efficiently wetted and have relatively low contact angles (i.e., below 30°), whereas low-energy surfaces are not wetted and have relatively high contact angles (i.e., above 90°).

“Disulfide” refers to a compound containing a bond between two sulfur atoms.

“Thiol” refers to a compound containing an —SH group.

“Thiolate” refers to a moiety corresponding to a thiol without the hydrogen of the —SH group.

“Ligand” refers to a binding partner of a receptor. Examples of ligands include cytokines and chemokines.

“Hapten” refers to a molecule or moiety that will bind to an antibody that is specific for that hapten. Examples of haptens include digoxigenin, fluorescien and phosphotyrosine.

### OVERVIEW OF THE INVENTION

A solid-phase affinity-based method for preparing an analyte-containing solution is provided comprising the steps of (1) providing an affinity capture surface comprising a substrate surface having a plurality of first and second surface modifiers associated therewith, wherein the first and second surface modifiers render the affinity capture surface wettable and resistant to non-specific protein adsorption, and wherein the second surface modifiers are capable of selectively retaining an analyte, (2) contacting the affinity capture surface with the analyte to form analyte/surface modifier complexes between the analyte and the second surface modifiers, and (3) cleaving the first and second surface modifiers to release terminal portions of the first and second surface modifiers and the analyte into a solution in contact with the affinity capture surface, thereby yielding the analyte-containing solution and generating a hydrophobic surface which is not wetted by the analyte-containing solution.

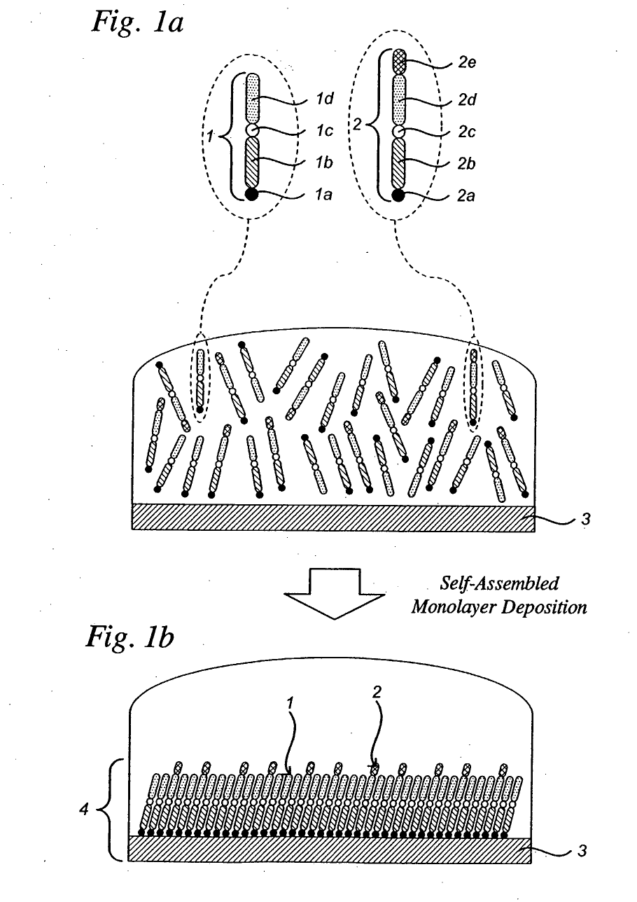

In the embodiment shown in FIGS. 1a and 1b, an affinity capture surface 4 is prepared by adsorption of a self-assembled monolayer comprising a plurality of first and second surface modifiers 1 and 2, respectively, onto a substantially planar substrate surface 3. Each first surface modifier, or background surface modifier, 1 comprises a terminal anchoring moiety 1a, which immobilizes the first surface modifier 1 on substrate surface 3; a linker moiety 1b, which stabilizes affinity capture surface 4 through van der Waal's interactions; a cleavable moiety 1c, which is cleavable by one of chemical, electrochemical and photochemical means; and a protein adsorption resistant moiety 1d, which minimizes the non-specific adsorption of peptides and proteins to affinity capture surface 4. Each second surface modifier, or affinity capture surface modifier, 2 comprises a terminal anchoring moiety 2a, which immobilizes the second surface modifier 2 on substrate surface 3; a linker moiety 2b, which stabilizes affinity capture surface 4 through van der Waal's interactions; a cleavable moiety 2c, which is cleavable by one of chemical, electrochemical and photochemical means; a protein adsorption resistant moiety 2d, which minimizes the non-specific adsorption of peptides and proteins to affinity capture surface 4; and an affinity capture moiety 2e, which is capable of selectively retaining an analyte.

Representative chemical, electrochemical and photochemical means for cleaving first and second surface modifiers 1 and 2 include, but are not limited to: (1) acid-catalyzed cleavage of acetals, cyclohexene-1,2-dicarboxylic acid amides, maleic acid amides, benzoyl esters, benzoyl carbamates, dihydropyran esters, thioesters, and silyl ethers; (2) base or nucleophilic cleavage of benzoyl esters, benzoyl thioesters, and sulfonic acid esters; (3) oxidation of phenols, catechols, hydroquinones, aromatic amines, aminophenols and thiols; (4) reduction of cinnamyl ethers, cinnamyl esters, cinnamyl carbamates, disulfides, nitroaromatics, nitrobenzyloxycarbonyl esters, nitrobenzyloxycarbonyl carbonates and nitrobenzyloxycarbonyl carbamates; and (5) photochemical cleavage of α-methylphenacyl esters and ortho-nitrobenzoyl esters.

Adsorption of fixed ratios of first and second surface modifiers 1 and 2 under standardized conditions (e.g., 1 mM thiol in ethanol for 24 hours at room temperature) affords affinity capture surface 4. Typically, the ratio of first surface modifiers 1 to second surface modifiers 2 is at least 5 to 1. More typically, the ratio of first surface modifiers 1 to second surface modifiers 2 is at least 10 to 1. Most typically, the ratio of first surface modifiers 1 to second surface modifiers 2 is at least 20 to 1.

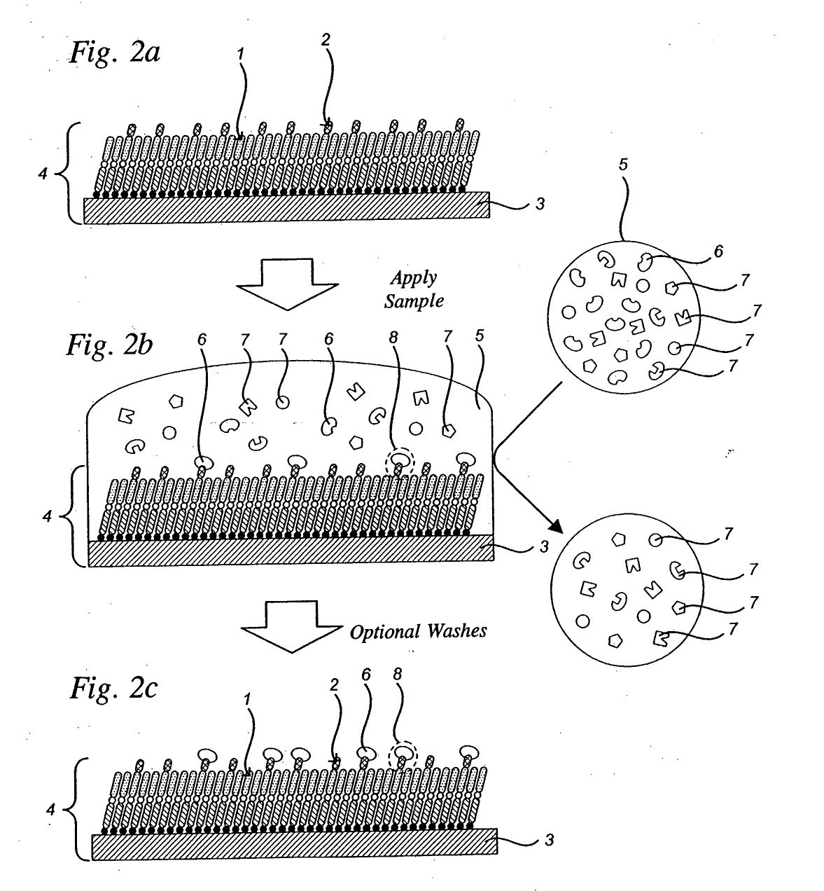

As shown in FIGS. 2a, 2b and 2c, contacting affinity capture surface 4 with a sample solution 5 containing target analytes 6 as well as untargeted analytes 7 facilitates the selective retention of target analytes 6 by second surface modifiers 2 to form analyte/surface modifier complexes 8. Following a period of incubation sufficient to ensure the quantitative retention of target analytes 6, sample solution 5 is then removed from affinity capture surface 4. Optionally, affinity capture surface 4 is subsequently washed with one or more solutions to further facilitate the removal of untargeted analytes 7.

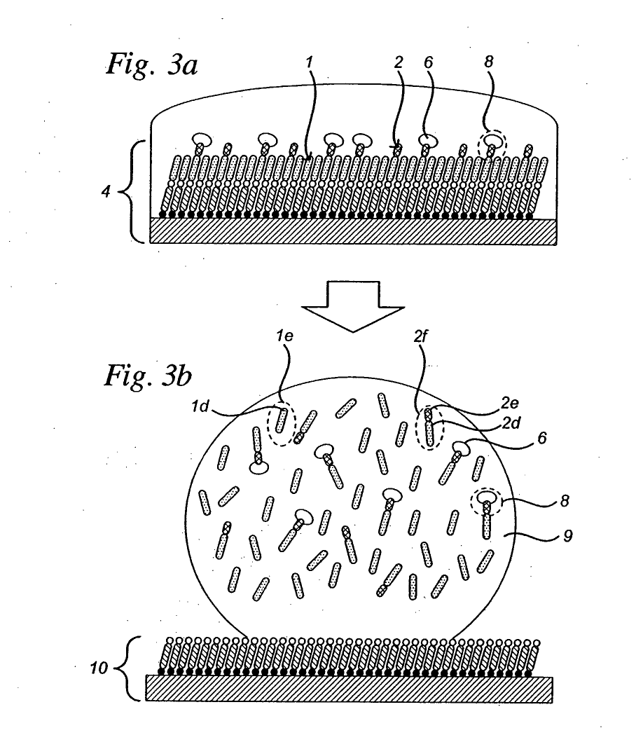

Following the formation of analyte/surface modifier complexes 8, and as further shown in FIGS. 3a and 3b, first and second surface modifiers 1 and 2 of affinity capture surface 4 are cleaved by one of chemical, electrochemical and photochemical means to yield analyte-containing solution 9 comprised of target analytes 6, terminal portions 1e of first surface modifier 1 and terminal portions 2f of second surface modifiers 2. As shown, terminal portions 1e comprise protein adsorption resistant moieties 1d and terminal portions 2f comprise protein adsorption resistant moieties 2d and affinity capture moieties 2e. In the embodiment of FIGS. 3a and 3b, analyte/surface modifier complexes 8 comprised of target analytes 6 and terminal portions 2f of second surface modifiers 2 remain associated in analyte-containing solution 9. The stability of such complexes is influenced by the composition of the solution into which the complexes are released, including considerations such as pH, ionic strength, the presence of detergents and the presence of organic solvents.

The residual surface 10 is hydrophobic and is not significantly wetted by analyte-containing solution 9. For example, in certain embodiments, analyte-containing solution 9 is an analyte-containing liquid droplet and cleavage of first and second surface modifiers 1 and 2 result in a change in contact angle of at least 30°.

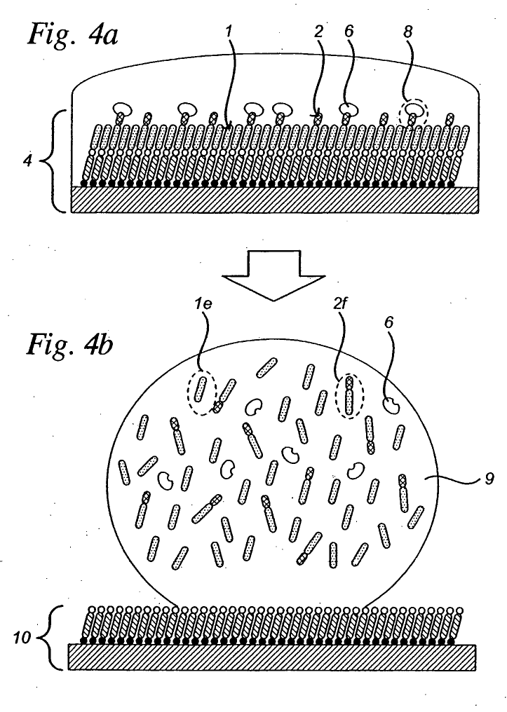

FIGS. 4a and 4b illustrate an alternate embodiment wherein analyte/surface modifier complexes 8 comprised of target analytes 6 and terminal portions 2f of second surface modifiers 2 disassociate in analyte-containing solution 9. As in FIGS. 3a and 3b, first and second surface modifiers 1 and 2 of affinity capture surface 4 are cleaved by one of chemical, electrochemical and photochemical means to yield analyte-containing solution 9 comprised of target analytes 6, terminal portions 1e of first surface modifier 1 and terminal portions 2f of second surface modifiers 2. In addition, as above, the stability of analyte/surface modifier complexes 8 is influenced by the composition of the solution into which the complexes are released, including considerations such as pH, ionic strength, the presence of detergents and the presence of organic solvents, and the residual surface 10 is hydrophobic and is not significantly wetted by analyte-containing solution 9.

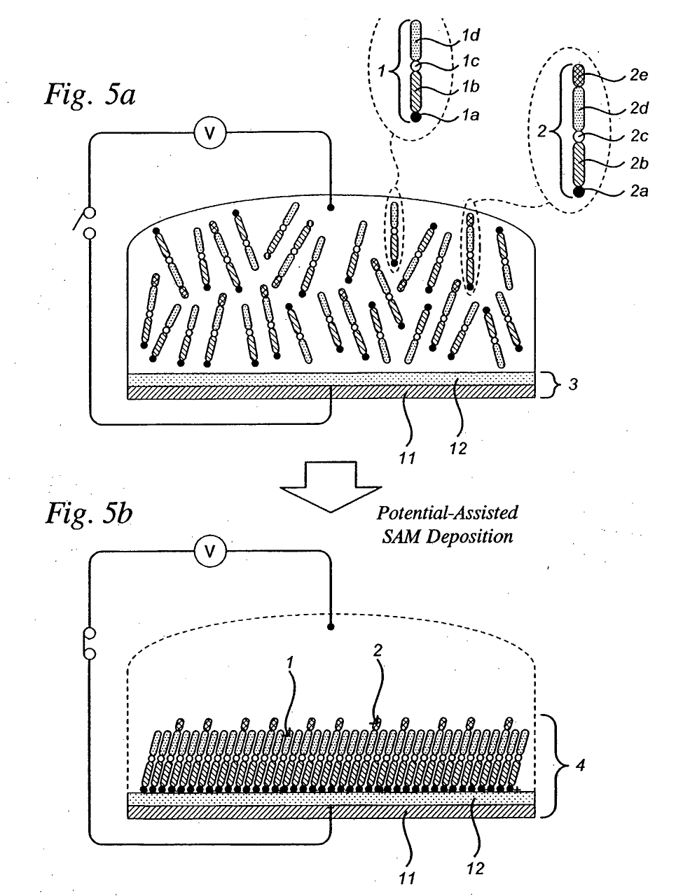

In the embodiment shown in FIGS. 5a and 5b, affinity capture surface 4 is prepared by potential-assisted deposition of a binary self-assembled monolayer comprised of a plurality of first and second surface modifiers 1 and 2 onto a substantially planar substrate surface 3 comprised of a substrate 11 having a thin film 12 of either gold or silver deposed thereon. Potential-assisted deposition results from applying a positive potential (e.g., in the range of from about +200 to about +800 mV) to thin film 12 during self-assembled monolayer deposition, and affords a substantial increase in the rate of self-assembled monolayer deposition and greater control over the ratio of first and second surface modifiers 1 and 2. Furthermore, potential-assisted deposition affords a self-assembled monolayer having fewer surface defects as evidenced by the greater capacitance of affinity capture surface 4 as compared to affinity capture surfaces prepared by open-circuit deposition.

As in FIGS. 1a and 1b above, each first surface modifier 1 comprises a terminal anchoring moiety 1a, which immobilizes the first surface modifier 1 on substrate surface 3; a linker moiety 1b, which stabilizes affinity capture surface 4 through van der Waal's interactions; a cleavable moiety 1c, which is cleavable by one of chemical, electrochemical and photochemical means; and a protein adsorption resistant moiety 1d which minimizes the non-specific adsorption of peptides and proteins to affinity capture surface 4. Similarly, each second surface modifier 2 comprises a terminal anchoring moiety 2a, which immobilizes the second surface modifier 2 on the substrate surface 3; a linker moiety 2b, which stabilizes affinity capture surface 4 through van der Waal's interactions; a cleavable moiety 2c, which is cleavable by one of chemical, electrochemical and photochemical means; a protein adsorption resistant moiety 2d, which minimizes the non-specific adsorption of peptides and proteins to affinity capture surface 4; and an affinity capture moiety 2e, which is capable of selectively retaining an analyte.

Under the conditions employed during potential-assisted deposition, terminal anchoring moieties 1a and 2a are negatively charged and are attracted to positively charged thin film 12 by electrostatic interactions. For example, in certain embodiments, terminal anchoring moieties 1a and 2a may be thiol or thiol-containing moieties. In addition, as described above, the ratio of first surface modifier 1 to second surface modifier 2 in the binary self-assembled monolayer is typically at least 5 to 1, more typically, at least 10 to 1, and most typically, at least 20 to 1.

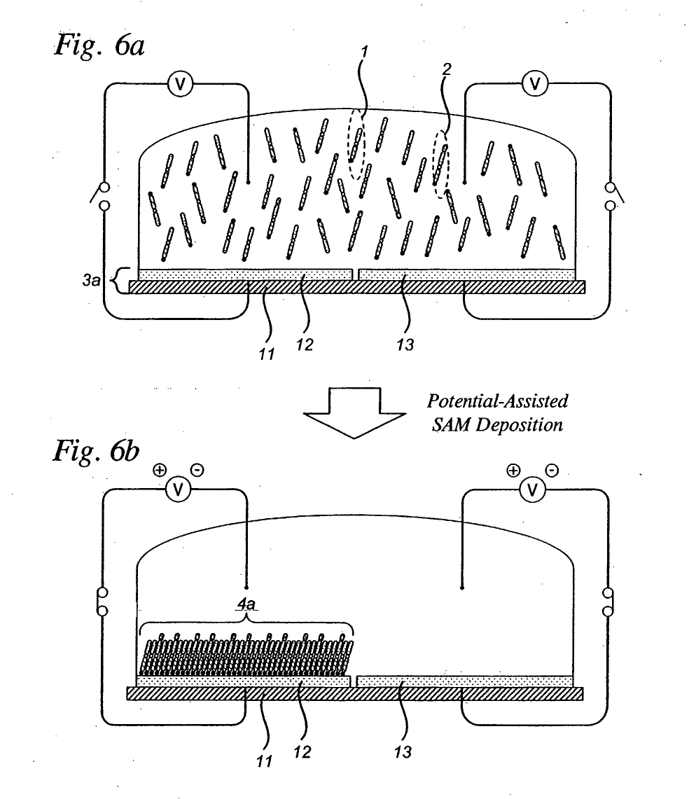

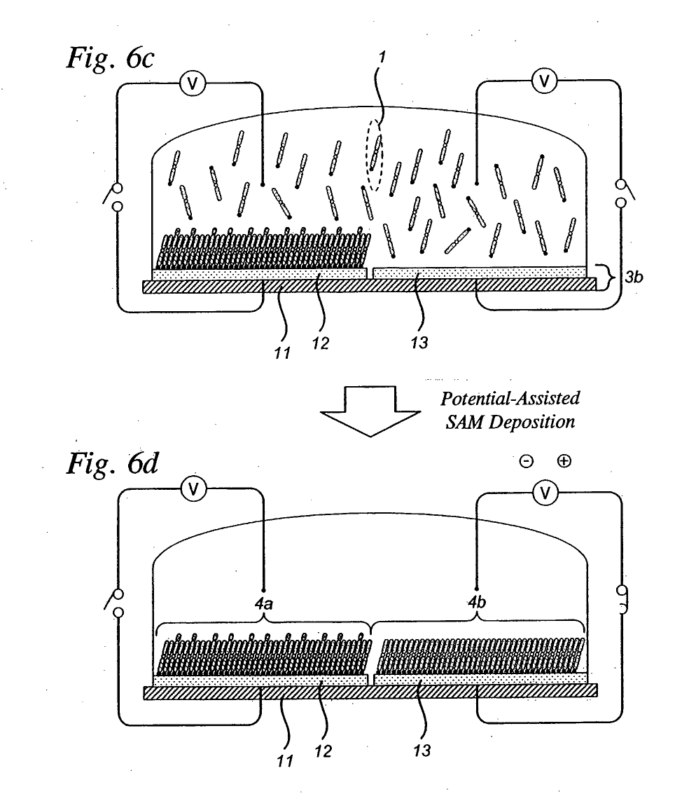

FIGS. 6a through 6d show the preparation of an affinity capture surface 4a and an adjacent surface-tension-directed transfer surface 4b. As shown in FIGS. 6a and 6b, affinity capture surface 4a is prepared by potential-assisted deposition of a first binary self-assembled monolayer comprised of a plurality of first and second surface modifiers 1 and 2, respectively, onto a first substantially planar substrate surface 3a comprised of a substrate 11 having a first metallic thin film 12 of either gold or silver deposed thereon. Potential-assisted deposition of the first self-assembled monolayer onto first thin film 12 results from applying a positive potential (e.g., in the range of from about +200 to about +800 mV, 0.1 mM thiol in ethanol, 30 min at room temperature) to first thin film 12 while simultaneously applying a negative potential (e.g., in the range of from about +800 mV to about +2000 mV) to a second metallic thin film 13 for a period of from about 15 to 60 minutes. The negative potential applied to second thin film 13 during the period of potential-assisted deposition prevents formation of first self-assembled monolayer on second thin film 13 (see, e.g., Mirsky, V. M., Trends in Analytical Chemistry (2002) 21, 439).

As further shown in FIGS. 6c and 6d, surface-tension-directed transfer surface 4b is prepared by potential-assisted deposition of a second self-assembled monolayer comprised of a plurality of first surface modifiers 1 onto a second substantially planar substrate surface 3b comprised of substrate 11 having a second metallic thin film 13 of either gold or silver deposed thereon. Potential-assisted deposition of the second self-assembled monolayer onto second thin film 13 results from applying a positive potential (in the range of from about +200 to about +800 mV) to second thin film 13 while simultaneously applying no potential to first thin film 12 for a period of from about 15 to 60 minutes. In the illustrated embodiment, transfer surface 4b is comprised only of first surface modifiers 1, however, in other embodiments, transfer surface 4b may also comprise second surface modifiers 2. Transfer surface 4b may be useful for surface-tension-directed liquid droplet manipulation, as further described below.

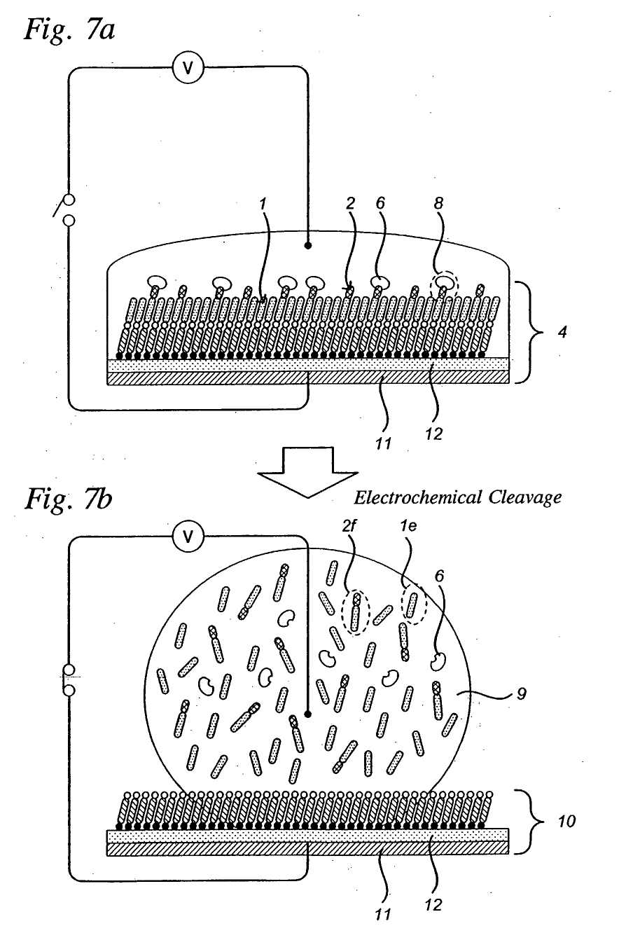

As illustrated in FIGS. 7a and 7b, following the potential-assisted preparation of an affinity capture surface 4, affinity capture surface 4 is contacted with a sample solution containing target analytes 6 to form analyte/surface modifier complexes 8. Subsequently, cleavable moieties 1c and 2c are severed by oxidation-reduction reactions to yield an analyte-containing solution 9 comprised of target analytes 6, terminal portions 1e of first surface modifiers 1 and terminal portions 2f of second surface modifiers 2. As in FIGS. 3a and 3b, terminal portions 1e comprise protein adsorption resistant moieties 1d and terminal portions 2f comprise protein adsorption resistant moieties 2d and affinity capture moieties 2e.

With further reference to FIGS. 7a and 7b, electrochemical cleavage of cleavable moieties 1c and 2c results from applying a potential (in the range of from about −800 to about +600 mV) to thin film 12 while grounding the contacting solution. In the illustrated embodiment, analyte/surface modifier complexes 8 comprised of target analytes 6 and terminal portions 2f of second surface modifiers 2 disassociate in analyte-containing solution 9. As above, the stability of such complexes is influenced by the composition of the solution into which the complexes are released, including considerations such as pH, ionic strength, presence of detergents and presence of organic solvents. In addition, also as above, the residual surface 10 is hydrophobic and is not significantly wetted by analyte-containing solution 9.

One of ordinary skill in the art will appreciate that electrochemistry may represent a preferred means of cleavage owing to various considerations including, but not limited to the following: (1) many oxidation-reduction reactions proceed rapidly as compared to chemical or photochemical reactions; (2) many well-characterized chemical moieties which undergo oxidation-reduction reactions afford moieties which are more hydrophobic than their precursors; and (3) the circuitry utilized to enable potential-assisted deposition of the self-assembled monolayer may be subsequently exploited for oxidation-reduction of cleavable moieties 1c and 2c.

### Affinity Capture Surface

As noted previously, the affinity capture surface of the present invention comprises a substrate surface having a plurality of first and second surface modifiers (background and affinity capture surface modifiers, respectively) associated therewith, wherein the first and second surface modifiers render the affinity capture surface wettable and resistant to non-specific protein adsorption, and wherein the second surface modifiers are capable of selectively retaining an analyte.

More specifically, the first surface modifiers have the following structure (I):

-A-L-X-Y₁ (I)

and the second surface modifiers have the following structure (II):

-A-L-X-Y₂-Z (II)

wherein each A is a terminal anchoring moiety which immobilizes each first and second surface modifier on the substrate surface, each L is a linker moiety which stabilizes the affinity capture surface through van der Waal's interactions, each X is a cleavable moiety which is cleavable by one of chemical, electrochemical and photochemical means, each Y₁ and Y₂ are protein adsorption resistant moieties which minimize the non-specific adsorption of peptides and proteins to the affinity capture surface, and each Z is an affinity capture moiety, such as a hapten or a ligand, which is capable of selectively retaining an analyte. In further embodiments, Z may comprise a reactive moiety to which a hapten or ligand is subsequently appended.

In further more specific embodiments:
A is —S—;
L is —(CH₂)ᵣ—;
X is

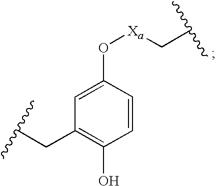

Y₁ is —(OCH₂CH₂)ₙOY₁ₐ;
Y₂ is —(OCH₂CH₂)ₚ—;
Xₐ is —C(═O)—, —C(═O)O—, —C(═O)NH—, —C(═O)S—, —SO₂—, —Si(CH₃)₂—, —Si(CH₂CH₃)₂—, —Si(CH(CH₃)₂—, —CH₂CH═CH— or —CH₂C₆H₄—;
Y₁ₐ is —H or —CH₃;
m is an integer from 2 to 16;
n is an integer from 3 to 7; and
p is an integer from 5 to 9.

In yet further more specific embodiments, Xₐ is —C(═O)—, Y₁ₐ is —H, m is an integer from 4 to 10, n is 3 or 4, p is an integer from 5 to 9 and the first and second surface modifiers have the following structures (I-A) and (II-A), respectively:

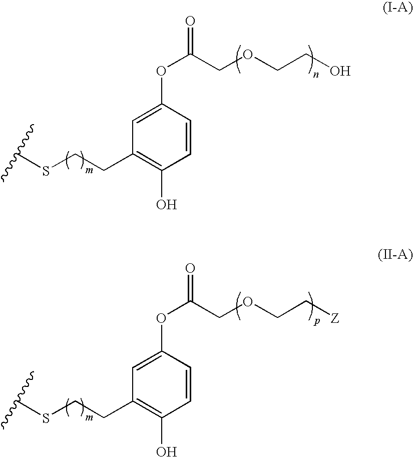

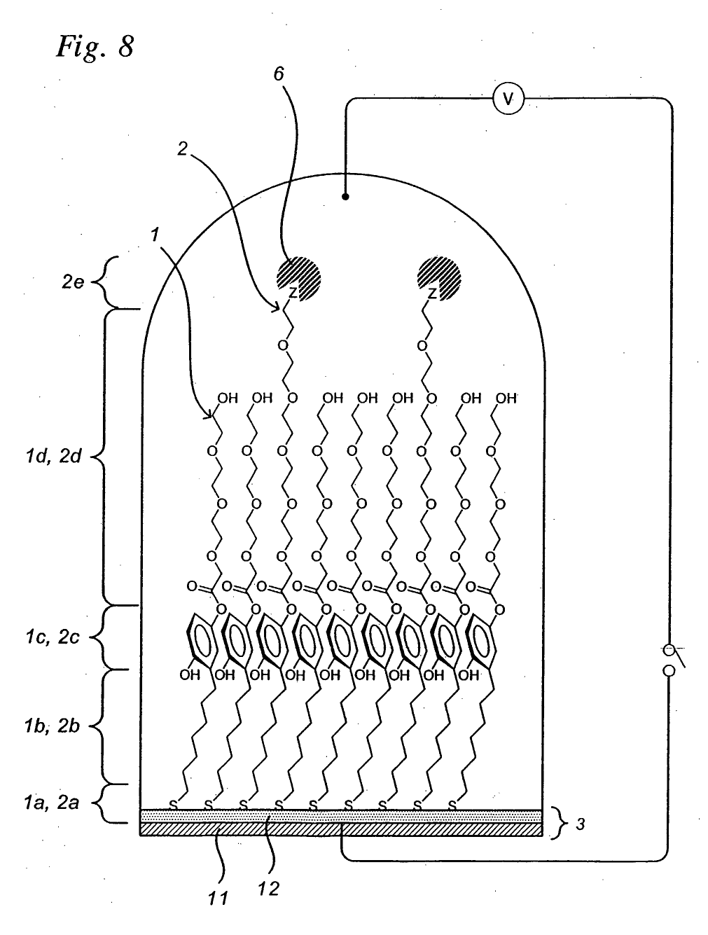

For example, FIG. 8 shows a representative affinity capture surface comprised of a substrate surface 3 having a plurality of first and second surface modifiers 1 and 2, respectively, associated therewith. For purposes of illustration, affinity capture moieties Z and retained target analytes 6 are represented generally.

With reference to FIG. 8, first surface modifiers 1 comprise a terminal anchoring moiety 1a which immobilizes first surface modifier 1 on substrate surface 3, a linker moiety 1b which stabilizes the affinity capture surface through van der Waal's interactions, a cleavable moiety 1c which is cleavable by electrochemical means, and a protein adsorption resistant moiety 1d which minimizes the non-specific adsorption of peptides and proteins to the affinity capture surface. More specifically, first surface modifiers 1 have the above structure (I-A) wherein m is 6 and n is 3.

With further reference to FIG. 8, second surface modifiers 2 comprise a terminal anchoring moiety 2a which immobilizes second surface modifier 2 on substrate surface 3, a linker moiety 2b which stabilizes the affinity capture surface through van der Waal's interactions, a cleavable moiety 2c which is cleavable by electrochemical means, a protein adsorption resistant moiety 2d which minimizes the non-specific adsorption of peptides and proteins to the affinity capture surface, and an affinity capture moiety 2e which is capable of selectively retaining an analyte. More specifically, second surface modifiers 2 have the above structure (II-A) wherein m is 6 and p is 5.

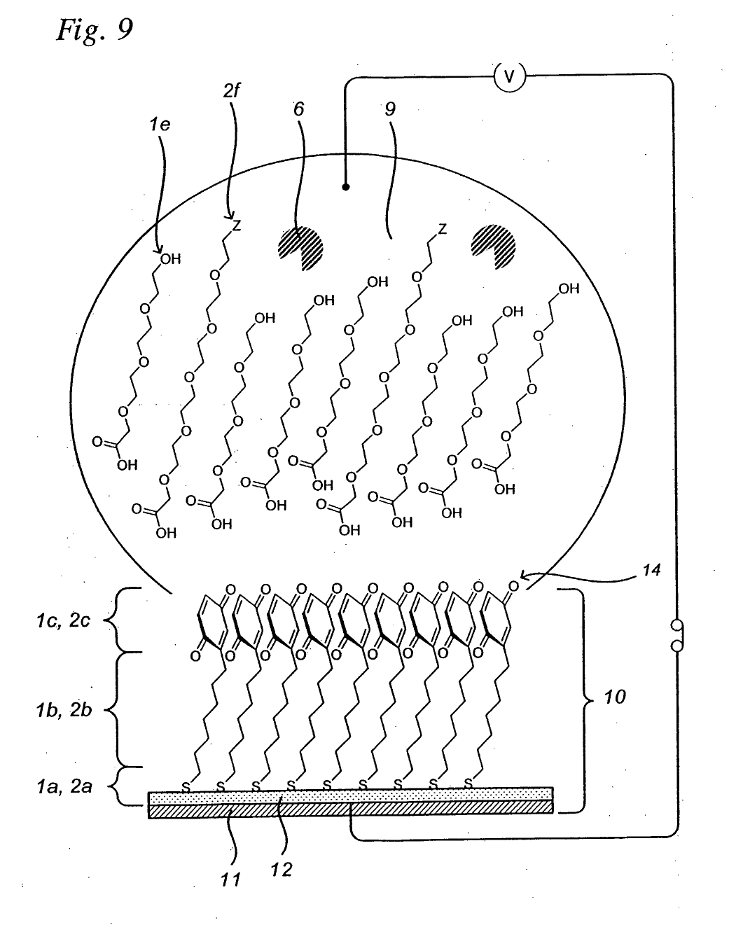

As shown in FIG. 9, cleavable moieties 1e and 2c are cleaved by electrochemical means to yield an analyte-containing solution 9 comprised of target analytes 6, terminal portions 1e of first surface modifiers 1 and terminal portions 2f of second surface modifiers 2. As shown, terminal portions 1e comprise protein adsorption resistant moieties 1d and terminal portions 2f comprise protein adsorption resistant moieties 2d and affinity capture moieties 2e. In the illustrated embodiment, electrochemical cleavage results from applying a potential in the range of from about +400 to about −900 mV to thin film 12 while grounding the contacting solution (the required oxidation potential is a function of the distance of cleavable moieties 1c and 2c from thin film 12 and, therefore, is directly related to the length of linkers 1b and 2b). In the illustrated embodiment, oxidation and cleavage of cleavable moieties 1e and 2c affords the corresponding quinone moieties 14 which are substantially more hydrophobic due to the oxidation of the hydrogen bond donating moieties associated with the precursor. In this way, the residual surface 10 is hydrophobic and is not significantly wetted by analyte-containing solution 9. Furthermore, residual surface 10 is sufficiently hydrophobic to enable surface-tension-directed liquid droplet transfer to an adjacent or contiguous hydrophilic site.

The affinity capture surfaces of the present invention may be prepared by contacting a substrate surface with (1) a plurality of first and second thiols having the following structures (III) and (IV), respectively:

HS-L-X-Y₁ (III)

HS-L-X-Y₂-Z (IV)

or (2) a plurality of first and second disulfides having the following structures (V) and (VI), respectively:

Y₁-X-L-S—S-L-X-Y₁ (V)

Z-Y₂-X-L-S—S-L-X-Y₂-Z (VI)

wherein, L, X, Y₁, Y₂ and Z are as defined above.

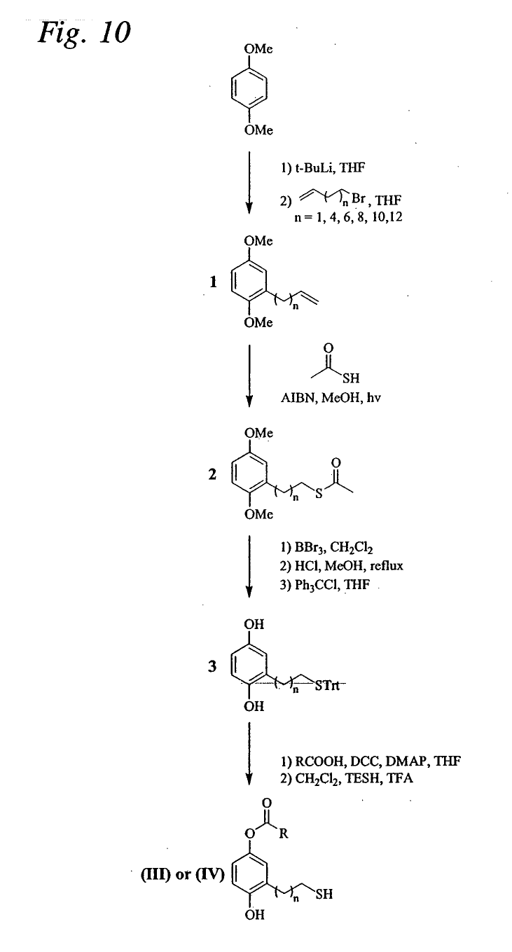

The foregoing thiols and disulfides may be synthesized using reagents and reactions well known to those of ordinary skill in the art, such as those described in “Advanced Organic Chemistry” J. March (Wiley & Sons, 1994) and “Organic Chemistry” 4^{th} ed., Morrison and Boyd (Allyn and Bacon, Inc., 1983). For example, FIG. 10 outlines a general synthetic scheme for the preparation of representative first and second thiols having the foregoing structures (III) and (IV). For purposes of illustration, in FIG. 10, R represents the remainder of the first and second thiols (i.e., -Y₁ or -Y₂-Z, respectively). The bromoalkene required for the preparation of synthetic intermediate 1 is obtained from the corresponding dibromoalkane, which is commercially available. The preparation of synthetic intermediate 2, wherein n=1, 4, 6, 8, 10 and 12, has been previously reported (see, e.g., Hong, H.-G., Park, W. and Yu, E., J. Electroanalytical Chem. (1999) 476, 177-181; and Hong, H.-G. and Park, W., Langmuir (2001) 17, 2485-2492). Furthermore, the preparation of synthetic intermediate 3, wherein n=6 to 14, has also been previously reported (see, e.g., Kwon, Y. and Mrksich, M., J. Amer. Chem. Soc. (2002) 124, 806-812; and Yeo, W.-S, and Mrkisch, M., Angew. Chem. Int. Ed. (2003) 42, 3121-3124).

When applied to a substrate surface comprising a metal, such as gold or silver, the foregoing thiols and disulfides will form self-assembled monolayers. In the case of the thiols, the SH bond is broken and the sulfur atom becomes coordinated to three metal atoms (via coordinate covalent bonds) on the substrate surface. In the case of the disulfides, the disulfide bridge is broken and each of the sulfur atoms becomes coordinated to adjacent sets of three metal atoms on the substrate surface. Once coordinated on the surface, the immobilized surface modifiers may be referred to as metal thiolate moieties.

The thiolate moieties of the present invention may cover the entire substrate surface alone or with other moieties, or may be patterned on the surface alone or with other moieties. Patterning may be carried out by, for example, microcontact printing (see, e.g., Mrksich, M., Dike, L. E., Tien, J., Ingber, D. E. and Whitesides, G. M., Experimental Cell Research (1997) 235, 305-313; Chen, C. S., Mrksich, M., Huang, S., Whitesides, G. M. and Ingber, D. E., Science (1997) 276, 1425-1428; and Mrksich, M. and Whitesides, G. M., TIBTECH. (1995) 13, 228-235).

### Analyte-Containing Solution

The analyte-containing solution prepared according to the method of the present invention is comprised of target analyte(s) and terminal portions of the first and second surface modifiers. As noted above, within the analyte-containing solution, the analyte/surface modifier complexes comprised of target analyte(s) and terminal portions of the second surface modifiers may be either associated or disassociated. The stability of such complexes is influenced by the composition of the solution into which the complexes are released, including considerations such as pH, ionic strength, the presence of detergents and the presence of organic solvents.

Representative analytes include, but are not limited to: biological macromolecules such as peptides, proteins, enzymes, enzyme substrates, enzyme substrate analogs, enzyme inhibitors, polynucleotides, oligonucleotides, nucleic acids, carbohydrates, oligosaccharides, polysaccharides, avidin, streptavidin, lectins, pepstatin, protease inhibitors, protein A, agglutinin, heparin, protein G and concanavalin; fragments of biological macromolecules set forth above, such as nucleic acid fragments, peptide fragments and protein fragments; complexes of biological macromolecules set forth above, such as nucleic acid complexes, protein-DNA complexes, gene transcription complexes, gene translation complexes, membrane liposomes, membrane receptors, receptor ligand complexes, signaling pathway complexes, enzyme-substrate, enzyme inhibitors, peptide complexes, protein complexes, carbohydrate complexes and polysaccharide complexes; small biological molecules, such as amino acids, nucleotides, nucleosides, sugars, steroids, lipids, metal ions, drugs, hormones, amides, amines, carboxylic acids, vitamins and coenzymes, alcohols, aldehydes, ketones, fatty acids, porphyrins, carotenoids, plant growth regulators, phosphate esters and nucleoside diphosphosugars; synthetic small molecules, such as pharmaceutically or therapeutically effective agents, monomers, peptide analogs, steroid analogs, inhibitors, mutagens, carcinogens, antimitotic drugs, antibiotics, ionophores, antimetabolites, amino acid analogs, antibacterial agents, transport inhibitors, surface-active agents (surfactants), aminecontaining combinatorial libraries, dyes, toxins, biotin, biotinylated compounds, DNA, RNA, lysine, acetylglucosamine, procion red, glutathione, adenosine monophosphate, mitochondrial and chloroplast function inhibitors, electron donors, carriers and acceptors, synthetic substrates and analogs for proteases, substrates and analogs for phosphatases, substrates and analogs for esterases and lipases and protein modification reagents; and synthetic polymers, oligomers, and copolymers, such as polyalkylenes, polyamides, poly(meth)acrylates, polysulfones, polystyrenes, polyethers, polyvinyl ethers, polyvinyl esters, polycarbonates, polyvinyl halides, polysiloxanes, and copolymers of any two or more of the above.

### Sample Presentation Devices

The sample presentation devices of the present invention utilize the foregoing methods and affinity capture surfaces in combination with surface-tension-directed liquid droplet manipulation, including electrowetting-on-dielectric liquid droplet manipulation, to position an analyte-containing solution for subsequent analysis by one or more analytical methodologies including, but not limited to, electrophoresis, high performance liquid chromatography (HPLC), matrix-assisted laser desorption/ionization time-of-flight mass spectrometry (MALDI-TOF-MS), optical microscopy, optical spectroscopy and surface plasmon resonance (SPR). In further embodiments, the sample presentation devices may be integral components of dedicated analyzers or biosensors.

The substrate surface of the sample presentation devices of the present invention may be on a base. The base may have the same composition as the substrate surface (for example, a gold surface on a gold plate), or the substrate surface may be, for example, a film, foil, sheet, or plate, on a base having a different composition. The base may be any material, such as metal, ceramic, plastic, or a natural material such as wood. Representative bases include glass, quartz, silicon, transparent plastic, aluminum, carbon, polyethylene and polypropylene.

The substrate surface material may be attached to the base by any of a variety of methods. For example, a film of the substrate surface material may be applied to the base by sputtering or evaporation. If the substrate surface material is a foil or sheet, it may be attached with an adhesive. Furthermore, the substrate surface need not completely cover the base, but may cover only a portion of the base, or may form a pattern on the base. For example, sputtering the base, and covering those portions of the base where no substrate surface material is desired, may be used to pattern portions of the base. These patterns may include an array of regions containing, or missing, the substrate surface material.

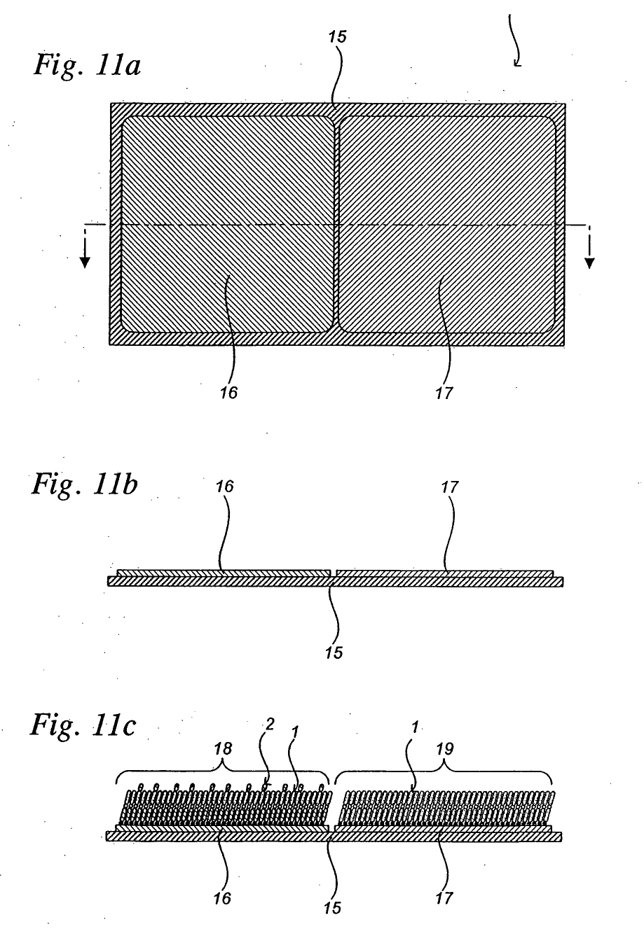

FIGS. 11a, 11b and 11c illustrate one embodiment of a representative sample presentation device 20 having adjacent, and separate, affinity capture and surface-tension-directed transfer surfaces. FIGS. 11a and 11b show a cross-sectional view of device 20 having a substantially planar nonconducting substrate 15, a first metallic thin film 16 and a second metallic thin film 17 adjacent to, and separated from, first thin film 16. The area defined by first thin film 16 comprises the affinity capture surface and the area defined by second thin film 17 comprises the surface-tension-directed transfer surface.

FIG. 11c shows device 20 having an affinity capture surface 18 comprised of a first binary self-assembled monolayer deposed onto first thin film 16 and a surface-tension-directed transfer surface 19 comprised of a second self-assembled monolayer deposed onto second thin film 17. The first binary self-assembled monolayer is comprised of first and second surface modifiers 1 and 2. The second self-assembled monolayer may be either a binary self-assembled monolayer comprised of both first surface modifiers 1 and second surface modifiers 2, or a homogeneous self-assembled monolayer comprised only of first surface modifiers 1.

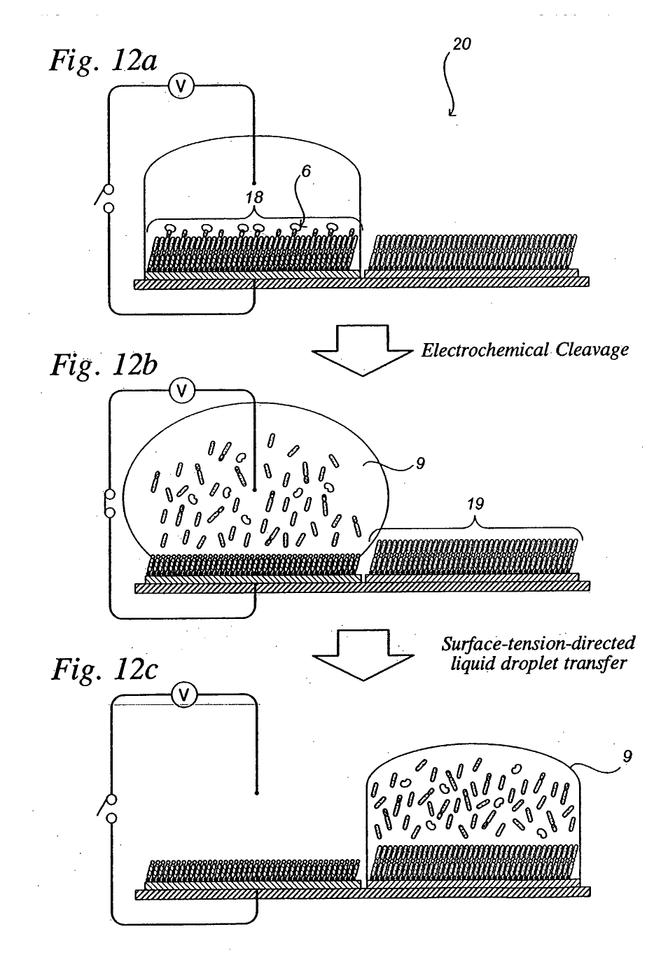

As further shown in FIGS. 12a, 12b and 12c, a method is illustrated whereby affinity capture surface 18 with retained target analytes 6 is cleaved by electrochemical means to afford an analyte-containing solution 9, which is subsequently transferred to adjacent surface-tension-directed transfer surface 19 by surface-tension-directed transfer from a low surface energy (hydrophobic) site to a high surface energy (hydrophilic) site.

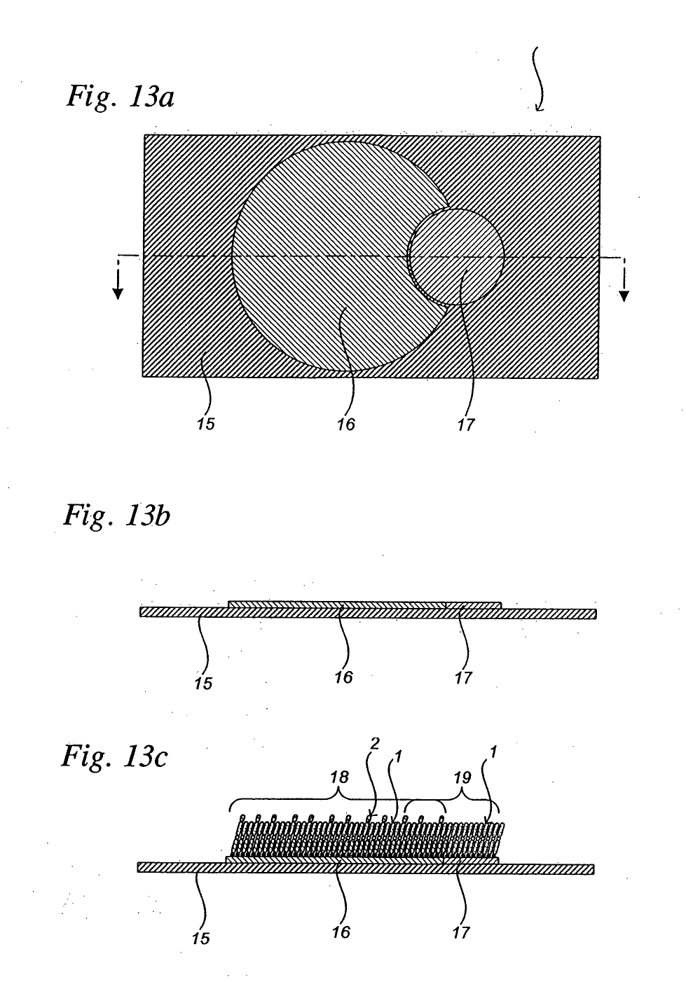

FIGS. 13a, 13b and 13c illustrate another embodiment of representative sample presentation device 20 wherein adjacent affinity capture and surface-tension-directed transfer surfaces are contiguous. FIGS. 13a and 13b show a cross-sectional view of device 20 having a substantially planar nonconducting substrate 15, a first metallic thin film 16 and a second metallic thin film 17 adjacent to, and contiguous with, first thin film 16. As in FIGS. 11a and 11b, the area defined by first thin film 16 comprises an affinity capture surface 18 and the area defined by second thin film 17 comprises a surface-tension-directed transfer surface 19. In the embodiment illustrated, surface-tension-directed transfer surface 19 is partially surrounded by affinity capture surface 18. In other embodiments, surface-tension-directed transfer surface 19 may be completely surrounded by affinity capture surface 18 or surface-tension-directed transfer surface 19 and affinity capture surface 18 may be side-by-side.

FIG. 13c shows device 20 having an affinity capture surface 18 comprised of a first binary self-assembled monolayer deposed onto first thin film 16 and a surface-tension-directed transfer surface 19 comprised of a second self-assembled monolayer deposed onto second thin film 17. As noted above, the first binary self-assembled monolayer is comprised of first and second surface modifiers 1 and 2, whereas the second self-assembled monolayer may be either a binary self-assembled monolayer comprised of both first and second surface modifiers 1 and 2, or a homogeneous self-assembled monolayer comprised only of first surface modifiers 1.

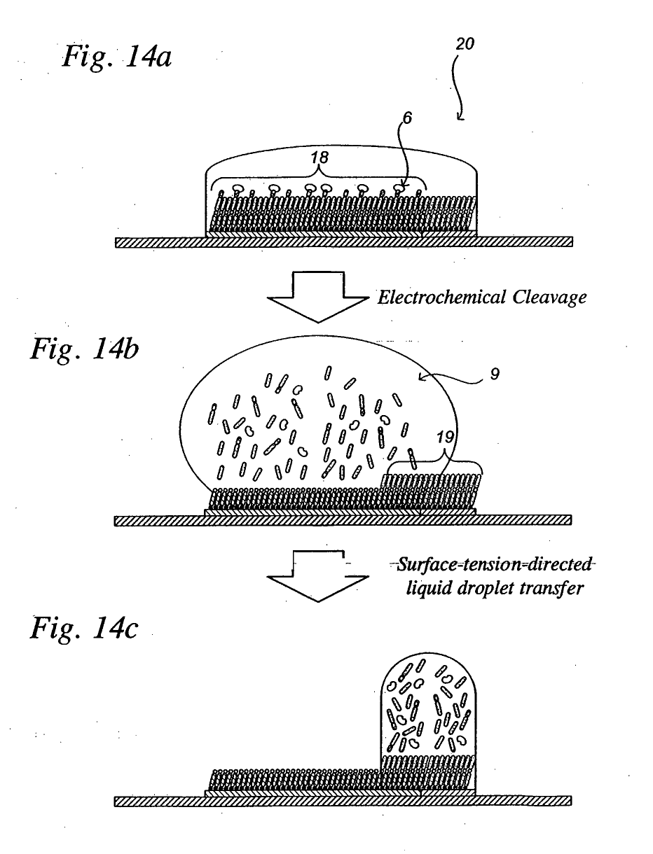

As further shown in FIGS. 14a, 14b and 14c, a method is illustrated whereby an affinity capture surface 18 with retained target analytes 6 is cleaved by electrochemical means to afford an analyte-containing solution 9, which is subsequently transferred to contiguous surface-tension-directed transfer surface 19 by surface-tension-directed transfer from a low surface energy (hydrophobic) site to a high surface energy (hydrophilic) site. In the illustrated embodiment, surface-tension-directed transfer surface 19 is smaller in area than affinity capture surface 18. In this way, sample presentation device 20 may be utilized to both transfer and focus analyte-containing solution 9.

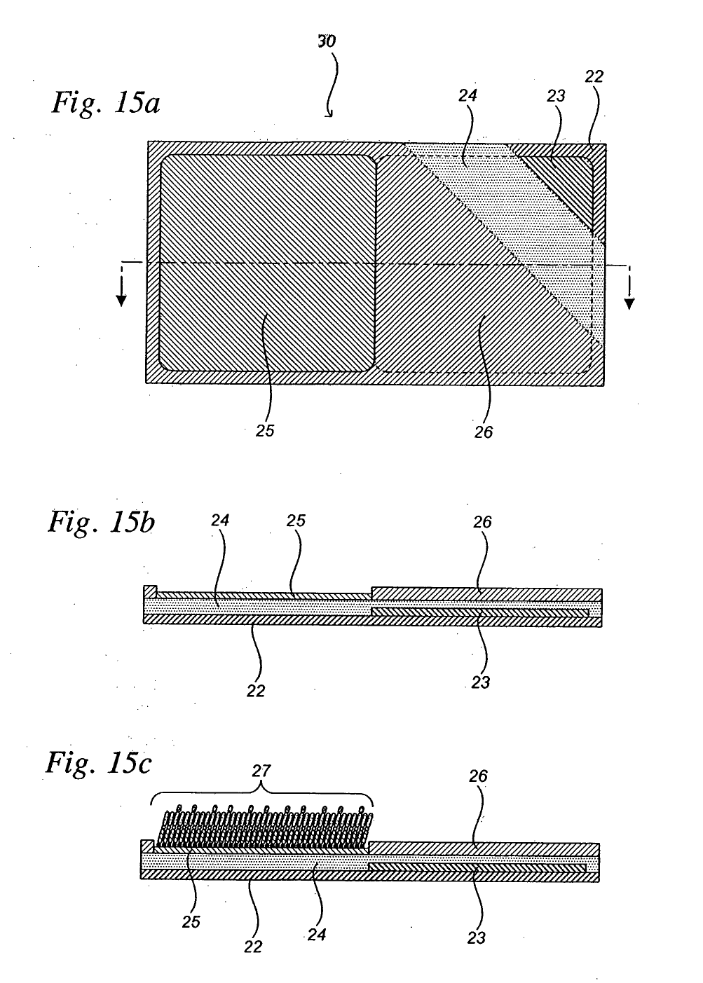

FIGS. 15a, 15b and 15c illustrate one embodiment of a representative sample presentation device 30 having adjacent affinity capture and electrowetting-on-dielectric transfer surfaces. FIGS. 15a and 15b show a cross-sectional view of device 30 having a substantially planar nonconducting substrate 22, an electrowetting control electrode 23, a dielectric thin film 24, a metallic thin film 25, and a hydrophobic thin film 26. The area defined by metallic thin film 25 comprises the affinity capture surface and the area defined by hydrophobic thin film 26 comprises the electrowetting-on-dielectric transfer surface. FIG. 15c shows device 30 having an affinity capture surface 27 comprised of a binary self-assembled monolayer deposed onto metallic thin film 25.

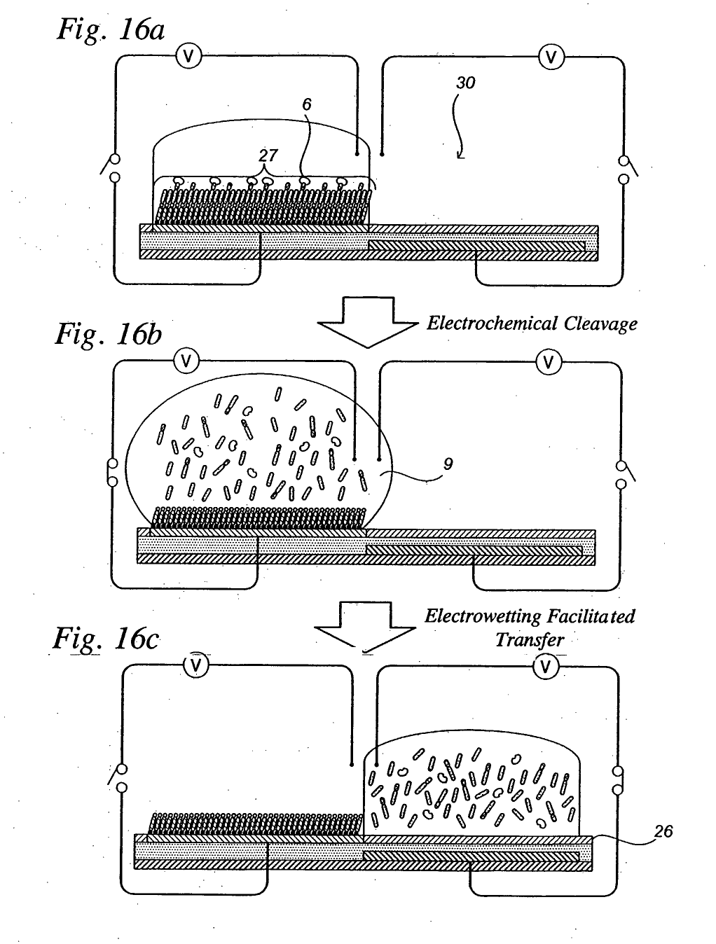

As further shown in FIGS. 16a, 16b and 16c, a method is illustrated whereby affinity capture surface 27 with retained target analytes 6 is cleaved by electrochemical means to afford an analyte-containing solution 9, which is subsequently transferred to the adjacent electrowetting-on-dielectric transfer site by electrowetting-on-dielectric facilitated liquid droplet manipulation. In the illustrated embodiment, the circuits that control the electrochemistry and electrowetting-on-dielectric are independent of one another.

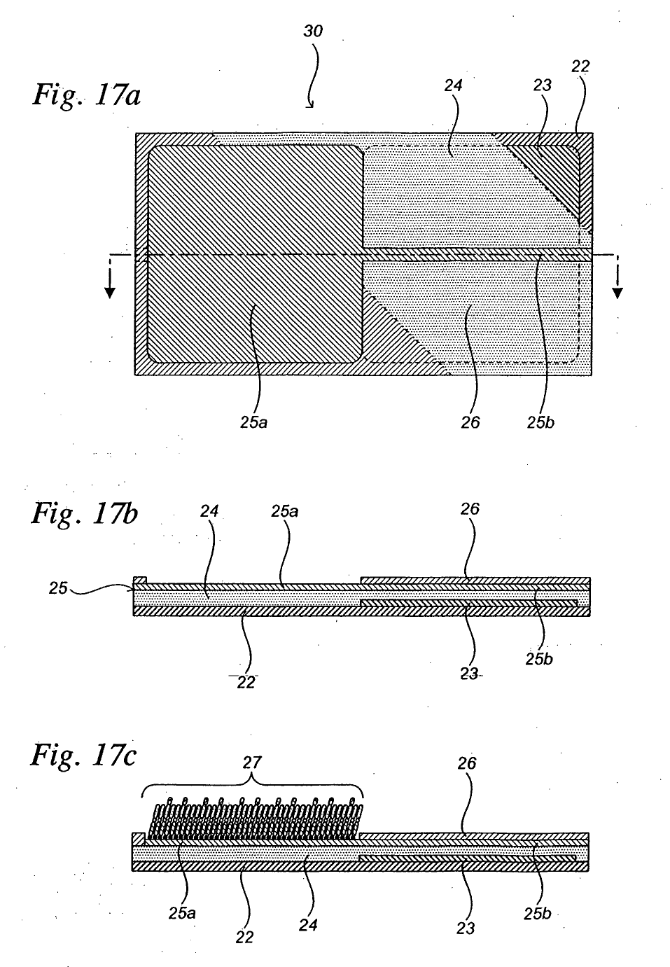

FIGS. 17a, 17b and 17c illustrate another embodiment of representative sample presentation device 30 having adjacent affinity capture and electrowetting-on-dielectric surface which share a common metallic thin film 25. FIGS. 17a and 17b show a cross-sectional view of device 30 having a substantially planar nonconducting substrate 22, an electrowetting control electrode 23, a dielectric thin film 24 and a metallic thin film 25 having two distinct regions 25a and 25b, the latter being covered by a hydrophobic thin film 26. The area defined by region 25a comprises the affinity capture surface and the area defined by region 25b comprises the electrowetting-on-dielectric transfer surface. FIG. 17c shows device 30 having an affinity capture surface 27 comprised of a binary self-assembled monolayer deposed onto region 25a of metallic thin film 25.

Region 25b of metallic thin film 25 may also serve as a ground electrode strip for the electrowetting-on-dielectric site when hydrophobic thin film 26 is sufficiently porous to enable conductivity between a liquid drop residing on the electrowetting-on-dielectric site and region 25b of metallic thin film 25.

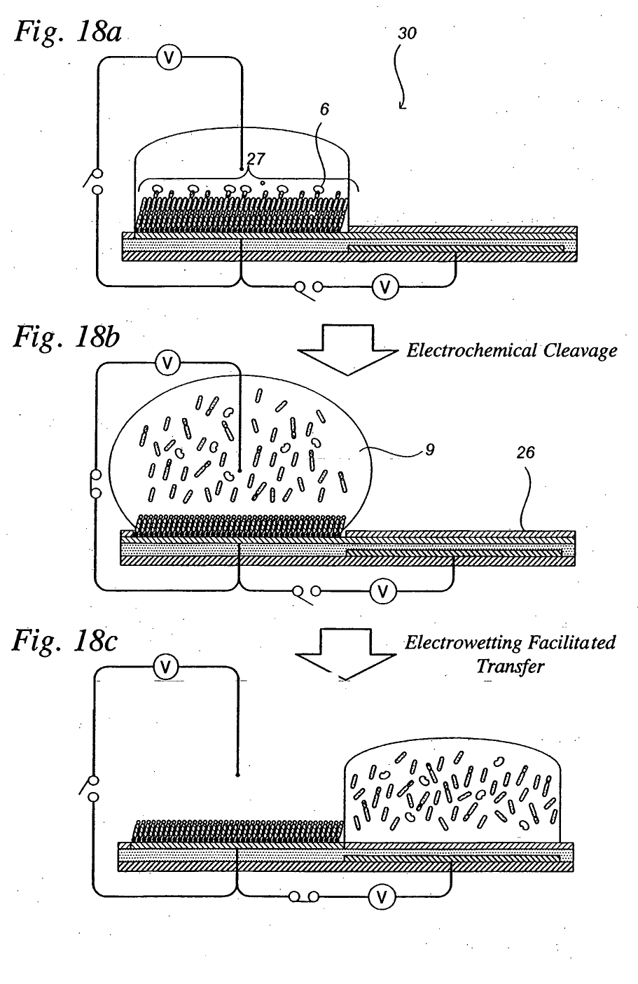

As further shown in FIGS. 18a, 18b and 18c, a method is illustrated whereby affinity capture surface 27 with retained target analytes 6 is cleaved by electrochemical means to afford an analyte-containing solution 9, which is subsequently transferred to the adjacent electrowetting-on-dielectric surface by electrowetting-on-dielectric facilitated liquid droplet manipulation. In the illustrated embodiment, the circuits that control the electrochemistry and electrowetting-on-dielectric share a common metallic thin film 25.

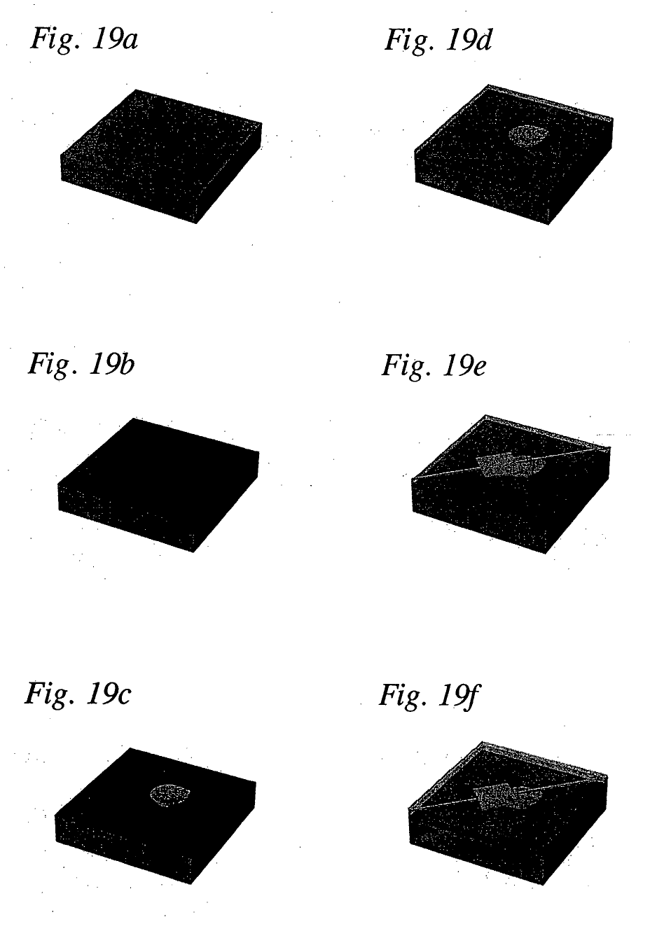

FIGS. 19a through 19f illustrate the steps in a method of fabricating a representative sample presentation device. FIG. 19a depicts a base substrate having the requisite dimensions and flatness. FIG. 19b depicts the deposition of a thermal oxide thin film on the base substrate to electrically insulate the electrowetting control electrodes from any conductivity associated with the base substrate. FIG. 19c depicts the patterning of gold electrowetting control electrodes on the thermal oxide film. FIG. 19d depicts the deposition of a silicon nitride dielectric layer. FIG. 19e depicts the patterning of a ground electrode and potential affinity capture site on the silicon nitride dielectric layer. FIG. 19e depicts the patterning of a hydrophobic thin film on the surface of the sample presentation device. Note that the surface of the potential affinity capture site remains exposed while the ground electrode is covered by the hydrophobic thin film. To complete the preparation of the sample presentation device, a self-assembled monolayer having first and second surface modifiers may be prepared on the exposed gold surface by potential-assisted deposition according to the method described above. The forgoing fabrication methodologies are familiar to those skilled in the art of semiconductor and micro electromechanical devices (MEMs) fabrication.

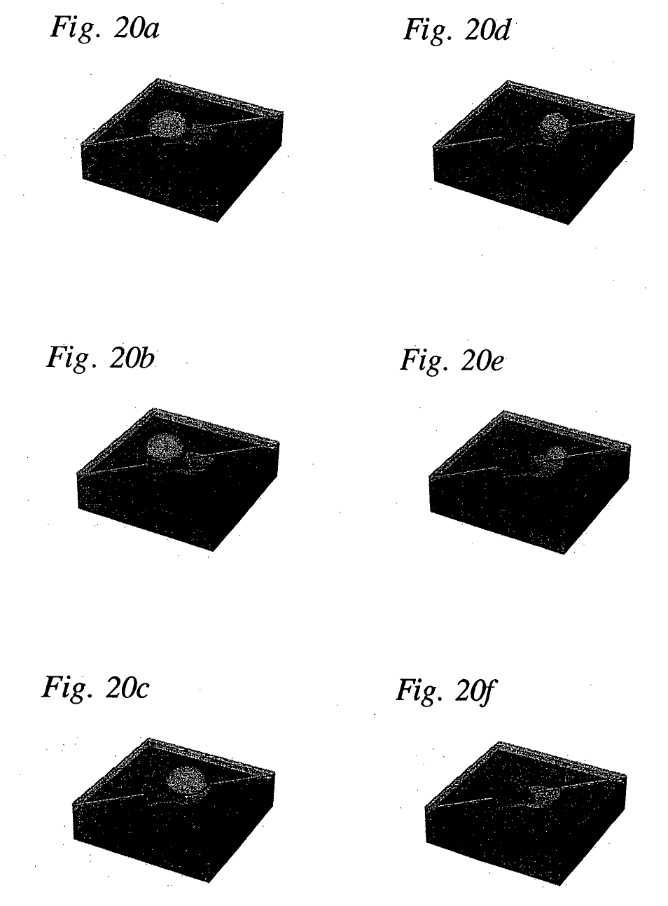

With reference to FIGS. 20a through 20f, a method for operating the sample presentation device of FIG. 19f is illustrated. FIG. 20a depicts a liquid drop residing upon an affinity capture surface with retained target analytes. FIG. 20b depicts the cleavage of the affinity capture surface by electrochemical means to afford an analyte-containing solution residing upon a hydrophobic surface. FIG. 20c depicts the transfer of the analyte-containing solution to an adjacent transfer surface by electrowetting-on-dielectric facilitated liquid droplet manipulation. FIGS. 20d, 20e and 20f depict the focusing of the analyte-containing solution into a confined space so as to enhance sensitivity of detection by further electrowetting-on-dielectric facilitated liquid droplet manipulation.

### EXAMPLES

### Example 1

### Synthesis of a Representative First Thiol

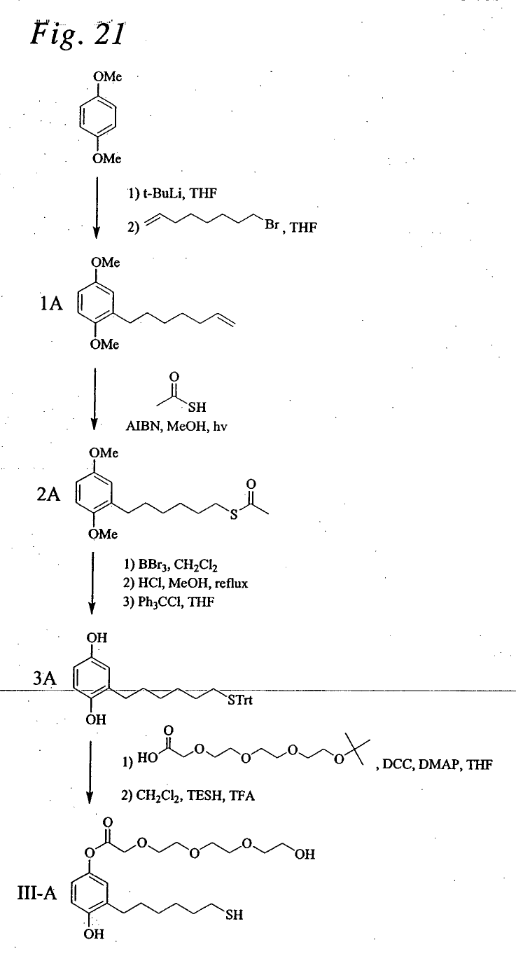

A first thiol, (III-A) was prepared as set forth in FIG. 21 and as described below.

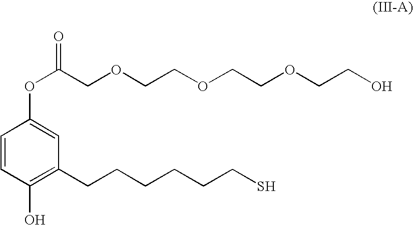

### Synthesis of Intermediate 1A: 2-Hept-6-enyl-1,4-dimethoxybenzene

To a solution of 1,4-dimethoxy-benzene (230 mg, 1.66 mmol) in THF (10 mL), was added t-butyl lithium in hexanes (1.7 M, 1.2 mL, 2.04 mmol) at 0° C. over a period of 5 min. The resulting pale yellow solution was stirred for 2 hrs and a solution of 8-bromo-oct-1-ene (440 mg, 2.30 mmol) in THF (5 mL) was added. The reaction mixture was warmed to room temperature and stirred overnight. The reaction mixture was diluted with ethyl acetate, washed with saturated NH₄Cl, then brine, and dried over MgSO₄. The organic layer was concentrated and the product purified by silica column chromatography with 20:1 hexane/ethyl acetate to afford 199 mg (51%) of intermediate 1A as a colorless oil.

### Synthesis of Intermediate 2A: Thioacetic acid S-[6-(2,5-demethoxyphenyl)hexyl]ester

To a solution of intermediate 1A (199 mg, 0.85 mmol) in methanol (30 mL) was added thiolacetic acid (0.25 mL, 3.5 mmol) and azobis(isobutylnitrile) (10 mg). The reaction mixture was irradiated in a photochemical reactor for 5 hrs under a nitrogen atmosphere. The reaction was concentrated and the product purified by silica column chromatography with 1:8 ethyl acetate/hexane to afford 219 mg (87%) of intermediate 2A as a yellowish oil.

### Synthesis of Intermediate 3A: 2-(6-Tritylsulfanylhexyl)benzene-1,4-diol

To a solution of intermediate 2A (219 mg, 0.64 mmol) in methylene chloride (10 mL), boron tribromide (0.35 mL, 3.7 mmol) was added at −78° C. The mixture was allowed to warm to room temperature and stirred for 2 hrs. The reaction was then cooled to −78° C. and quenched by addition of diethyl ether and water. The reaction mixture was washed with water, then brine, and dried over MgSO₄. The organic layer was concentrated and the product purified by silica column chromatography with 1:2 ethyl acetate/hexane to afford 220 mg (94%) of thioacetic acid S-[6-(2,5-dihydroxy-phenylhexyl]ester as a white powder.

Thioacetic acid S-[6-(2,5-dihydroxyphenylhexyl]ester (161 mg, 0.60 mmol) was dissolved in methanol (20 mL) and was treated with concentrated hydrochloric acid (0.5 mL, 6 mmol). The reaction mixture was then heated under reflux overnight. The solvent was evaporated and the residue dissolved in ethyl acetate. The organic layer was washed with water, dried over MgSO₄, and concentrated to afford 136 mg (100%) of 2-(6-mercapto-hexyl)benzene-1,4-diol as a white powder.

To a solution of 2-(6-mercaptohexyl)benzene-1,4-diol (136 mg, 0.6 mmol) in THF (20 mL) was added triphenylmethyl chloride (200 mg, 0.72 mmol), and the mixture was stirred for 6 hrs at 50° C. The solvent was concentrated and the product purified by silica column chromatography with 1:2 ethyl acetate/hexane to afford 394 mg (84%) of intermediate 3A as a pale yellow powder.

### Synthesis of First Thiol (III-A): {2-[2-(2-Hydroxyethoxy)ethoxy]ethoxy}acetic acid 4-hydroxy-3-(6-mercaptohexyl)phenyl ester

To a solution of intermediate 3A (100 mg, 0.213 mmol) in THF (10 mL), was added {2-[2-(2-tert-butoxyethoxy)ethoxy]ethoxy}acetic acid (56 mg, 0.213 mmol), dicyclohexylcarbodiimide (47 mg, 0.230 mmol) and 4-dimethylaminopyridine (2.5 mg, 0.02 mmol) at 0° C. The reaction mixture was stirred overnight, diluted with ethyl acetate, washed with saturated NH₄Cl, then brine, and dried over MgSO₄. The organic layer was concentrated and the product purified by silica column chromatography with 1:4 ethyl acetate/hexane to give 22 mg (22%) of {2-[2-(2-tert-butoxyethoxy-ethoxy]ethoxy}acetic acid 4-hydroxy-3-(6-tritylsulfanylhexyl)phenyl ester as a colorless oil.

To a solution of {2-[2-(2-tert-butoxyethoxy)ethoxy]ethoxy}acetic acid 4-hydroxy-3-(6-tritylsulfanylhexyl)phenyl ester (22 mg, 0.047 mmol) in methylene chloride (10 mL) was added 1 mL of TFA followed by triethylsilane (15 μL, 0.094 mmol).

The mixture was stirred for 1 hr and the solvent was concentrated and the product purified by silica column chromatography with 1:4 ethyl acetate/hexane to give 19 mg (100%) of first thiol (III-A) as a white powder.

### Example 2

### Synthesis of a Representative Second Thiol

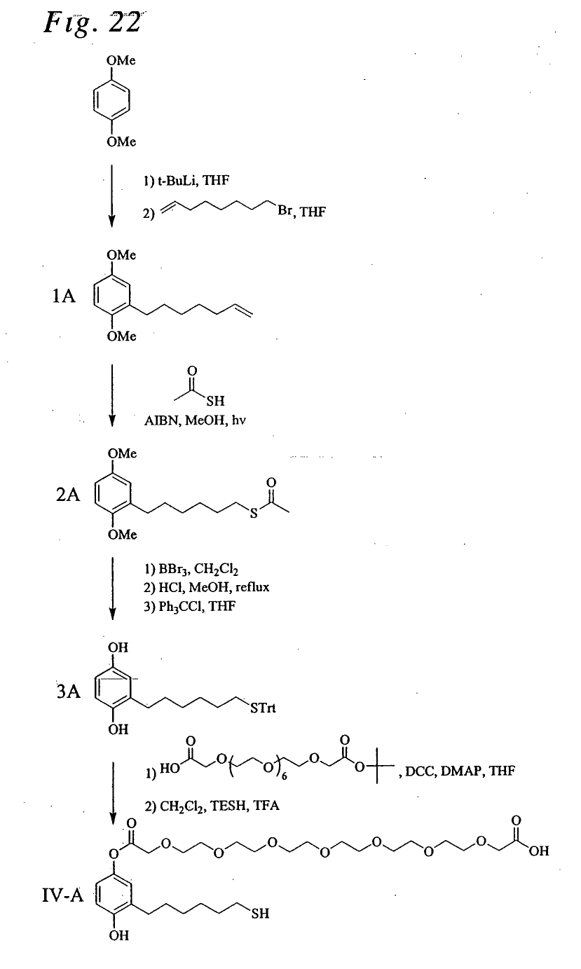

A second thiol, (IV-A) was prepared as set forth in FIG. 22 and as described below. After incorporation into a binary self-assembled monolayer, the affinity capture surface may be activated to append a hapten or ligand to the terminal carboxylic acid reactive moiety.

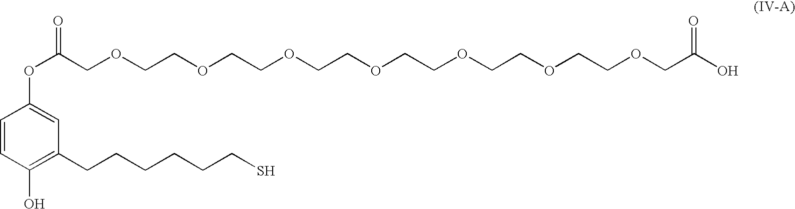

### Synthesis of Second Thiol (IV-A): [2-(2-{2-[2-(2-{2-[4-Hydroxy-3-(6-mercaptohexyl)phenoxycarbonyl-methoxy]ethoxy}ethoxy)ethoxy]ethoxy}ethoxy)ethoxy]acetic acid

To a solution of intermediate 3A (100 mg, 0.213 mmol), prepared as set forth in Example 1, in THF (10 mL), was added {2-[2-(2-{2-[2-(2-tert-butoxycarbonylmethoxyethoxy)ethoxy]ethoxy}ethoxy)ethoxy]ethoxy}acetic acid (97 mg, 0.213 mmol), dicyclohexylcarbodiimide (47 mg, 0.230 mmol) and 4-dimethylaminopyridine (2.5 mg, 0.02 mmol) at 0° C. The reaction mixture was stirred overnight, diluted with ethyl acetate, washed with saturated NH₄Cl, then brine, and dried over MgSO₄. The organic layer was concentrated and the product purified by silica column chromatography with 1:4 ethyl acetate/hexane to give 54 mg (28%) of {2-[2-(2-{2-[2-(2-tert-butoxycarbonylmethoxyethoxy)ethoxy]ethoxy}ethoxy)ethoxy]ethoxy}acetic acid 4-hydroxy-3-(6-tritylsulfanylhexyl)phenyl ester.

To a solution of {2-[2-(2-{2-[2-(2-tert-butoxycarbonylmethoxyethoxy)ethoxy]-ethoxy}ethoxy)ethoxy]ethoxy}acetic acid 4 hydroxy-3-(6-tritylsulfanylhexyl)phenyl ester (54 mg, 0.060 mmol) in methylene chloride (10 mL) was added 1 mL of TFA followed by triethylsilane (11 μL, 0.120 mmol). The mixture was stirred for 1 hr and the solvent was concentrated and the product purified by silica column chromatography with 1:4 ethyl acetate/hexane to give 36 mg (100%) of 5 second thiol (IV-A) as a white powder.

### Example 3

### Preparation of a Representative Affinity Capture Surface by Open-Circuit Deposition

A silicon substrate measuring 2.0 cm² with a sputtered gold surface (250 Å) was cleaned in a UV/ozone apparatus and then immersed in a solution of ethanol (10 mL) containing 0.95 mM {2-[2-(2-hydroxyethoxy)ethoxy]ethoxy}acetic acid 4-hydroxy-3-(6-mercaptohexyl)phenyl ester and 0.05 mM [2-(2-{2-[2-(2-{2-[4-hydroxy-3-(6-mercapto-hexyl)phenoxycarbonylmethoxy]ethoxy}ethoxy)ethoxy]ethoxy}ethoxy)ethoxy]acetic acid for 24 hrs at room temperature. The substrate was then washed by repeated immersion in ethanol and dried under a stream of nitrogen. The resulting binary self-assembled monolayer was comprised of 90-95% of the hydroxyl (—OH) terminated monomer and 5-10% of the carboxylic acid (—C(═O)OH) terminated monomer.

### Example 4

### Preparation of a Representative Affinity Capture Surface by Potential Assisted Deposition

A silicon substrate measuring 2.0 cm² with a sputtered gold surface (250 Å) was cleaned in a UV/ozone apparatus. An electrode was attached to the gold surface and the substrate was immersed in a solution of ethanol (10 mL) containing 0.095 mM {2-[2-(2-hydroxy-ethoxy)ethoxy]ethoxy}acetic acid 4-hydroxy-3-(6-mercaptohexyl)phenyl ester and 0.005 mM [2-(2-{2-[2-(2-{2-[4-hydroxy-3-(6-mercaptohexyl)phenoxycarbonylmethoxy]ethoxy}ethoxy)-ethoxy]ethoxy}ethoxy)ethoxy]acetic acid. A ground electrode was placed in the ethanol solution and a potential of +400 mV was applied to the gold surface for 30 min. Finally, the substrate was washed by repeated immersion in ethanol and dried under a stream of nitrogen. The resulting binary self-assembled monolayer was comprised of 90-95% of the hydroxyl terminated monomer and 5-10% of the carboxylic acid terminated monomer.

### Example 5

### Activation of Affinity Capture Surface

The affinity capture surface prepared in Example 3 or Example 4 was activated by immersion in an aliquot (10 mL) of a 100 mL stock solution containing 750 mg of 1-ethyl-3(3-dimethylaminopropyl)-carbodiimide (EDC) and 115 mg of N-hydroxysuccinimide (NHS) in water for 30 min at room temperature. The affinity capture surface was removed from the activation solution and washed with 10 mM sodium acetate buffer, pH 5.0 (3×10 mL). A 10 mL solution containing a ligand with pendant amine functionality (10 mmol) was prepared in 10 mM sodium acetate buffer, pH 5.0 and the affinity capture surface was immersed in the ligand coupling solution for 1 hr at room temperature. The affinity capture surface was then washed with 10 mM sodium acetate buffer, pH 5.0 (3×10 mL). Finally, the affinity capture surface (with immobilized ligand) was treated with 10 mL of ethanolamine hydrochloride buffer, pH 10.5 to hydrolyze remaining NHS esters and then further washed with 10 mM sodium acetate buffer, pH 5.0 (3×10 mL).

### Example 6

### Fabrication of a Representative Sample Presentation Device

The sample presentation device of FIG. 17 was fabricated according to the following method.

The surface of a 4″ silicon wafer was exposed to wet O₂/N₂ at 1045° C. for 45 min to prepare a thermal oxide (2500 Å) insulator film thereon. A first metal conductive layer, comprised of 60 Å of Ti/W, 300 Å of Au and 60 Å of Ti/W was then sputtered onto the thermal oxide insulator film surface. A first photoresist layer was then spin-coated and patterned by contact printing to define the electrode pattern. The first metal conductive layer was then wet etched at room temperature employing the following sequence: (1) 30% H₂O₂ in TFA for 90 sec; (2) 30% H₂O₂ for 30 sec; and (3) 30% H₂O₂ in TFA for 90 sec. The first photoresist layer was then stripped using reagent EKC830 for 10 min followed by reagent AZ300 for 5 min. The resulting wafers were rinsed in deionized water and dried in a vacuum spinner. Unstressed silicon nitride dielectric (1000 Å) was then deposited by PECVD (plasma enhanced chemical vapor deposition) at 350° C. on the surface of the wafers and a second photoresist layer was spin-coated and patterned by contact printing to expose contacts (connectors) and vias. The silicon nitride dielectric layer was dry etched through the second photoresist mask by reactive ion etching (RIE) with sulfur hexafluoride gas. A second metal conductive layer, comprised of 300 Å of Au and 60 Å of Ti/W, was then sputtered onto the silicon nitride surface. To provide adequate gold depth at the contacts an additional 1000 Å of Au was deposited on the contacts by shadow masking. A third photoresist layer was spin-coated and patterned by contact printing to define the upper ground electrode, affinity capture site and contact pattern. The metal conductive film was wet etched at room temperature with 30% H₂O₂ in TFA for 90 sec and 30% H₂O₂ for 30 sec. The resulting wafers were protected with a fourth photoresist layer and diced into chips. The photoresist was then stripped using reagent EKC830 for 10 min followed by reagent AZ300 for 5 min and the wafers were rinsed in deionized water and dried in a vacuum spinner. Finally, a solution of CYTOP Amorphous Fluorocarbon Polymer (1.1% in CYTOP proprietary solvent) was spin-coated at 2500 rpm and dried at 120° C. for 10 min; 150° C. for 10 min; and 180° C. for 10 min to yield the sample presentation device of FIG. 17.

All of the above U.S. patents, U.S. patent application publications, U.S. patent applications, foreign patents, foreign patent applications and non-patent publications referred to in this specification are incorporated herein by reference in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method for preparing an analyte-containing solution, the method comprising the steps of:
providing an affinity capture surface comprising a substrate surface having a plurality of first and second surface modifiers associated therewith, wherein the first and second surface modifiers render the affinity capture surface wettable and resistant to non-specific protein adsorption, and wherein the second surface modifiers are capable of selectively retaining an analyte;
contacting the affinity capture surface with the analyte to form analyte/surface modifier complexes between the analyte and the second surface modifiers; and
cleaving the first and second surface modifiers to release terminal portions of the first and second surface modifiers and the analyte into a solution in contact with the affinity capture surface, thereby yielding the analyte-containing solution and generating a hydrophobic surface.

2. The method of claim 1 wherein the analyte-containing solution is an analyte-containing liquid droplet.

3. The method of claim 2 wherein the contact angle of the analyte-containing liquid droplet, with respect to the hydrophobic surface, is at least 30° greater than the contact angle of the solution in contact with the affinity capture surface.

4. The method of claim 2, further comprising the step of transferring the analyte-containing liquid droplet to an adjacent transfer surface by surface-tension-directed liquid droplet manipulation.

5. The method of claim 2, further comprising the step of transferring the analyte-containing liquid droplet to an adjacent transfer surface by electrowetting-on-dielectric facilitated liquid droplet manipulation.

6. The method of claim 4 or claim 5 wherein the adjacent transfer surface is separated from the affinity capture surface.

7. The method of claim 4 or claim 5 wherein the adjacent transfer surface is contiguous with the affinity capture surface.

8. The method of claim 7 wherein the adjacent transfer surface is partially surrounded by the affinity capture surface.

9. The method of claim 7 wherein the adjacent transfer surface is completely surrounded by the affinity capture surface.

10. The method of claim 1 wherein the ratio of the first surface modifiers to the second surface modifiers is at least 5 to 1.

11. The method of claim 10 wherein the ratio of the first surface modifiers to the second surface modifiers is at least 10 to 1.

12. The method of claim 11 wherein the ratio of the first surface modifiers to the second surface modifiers is at least 20 to 1.

13. The method of claim 1 wherein:
the first surface modifiers have the structure:
-A-L-X-Y₁; and
the second surface modifiers have the structure:
-A-L-X-Y₂-Z,
wherein each A is a terminal anchoring moiety associated with the substrate surface, L is a linker moiety, X is a cleavable moiety, Y₁ and Y₂ are protein adsorption resistant moieties and Z is an affinity capture moiety.

14. The method of claim 13 wherein:
A is —S—;
L is —(CH₂)ₘ—;
X is 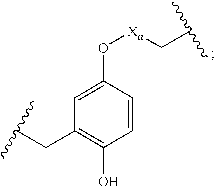
Y₁ is —(OCH₂CH₂)ₙOY₁ₐ;
Y₂ is —(OCH₂CH₂)ₚ—;
Xₐ is —C(═O)—, —C(═O)O—, —C(═O)NH—, —C(═O)S—, —SO₂—, —Si(CH₃)₂—, —Si(CH₂CH₃)₂—, —Si(CH(CH₃)₂—, —CH₂CH═CH— or —CH₂C₆H₄—;
Y₁ₐ is —H or —CH₃;
m is an integer from 2 to 16;
n is an integer from 3 to 7; and
p is an integer from 5 to 9.

15. The method of claim 14 wherein Xₐ is —C(═O)—, Y₁ₐ is —H, m is an integer from 4 to 10, n is 3 or 4, and p is an integer from 5 to 9.

16. The method of claim 13 wherein the substrate surface comprises metal.

17. The method of claim 16 wherein the substrate surface comprises gold.

18. The method of claim 13 wherein Z comprises a hapten or a ligand.

19. The method of claim 13 wherein Z comprises a reactive moiety capable of retaining a hapten or ligand.

20. The method of claim 1 wherein the first and second surface modifiers are cleaved by electrochemical, chemical or photochemical means.

21. The method of claim 20 wherein the first and second surface modifiers are cleaved by electrochemical means.

22. The method of claim 21 wherein the electrochemical means comprise applying a reducing potential to the substrate surface.

23. The method of claim 1 wherein the analyte and the terminal portions of the second surface modifiers disassociate in the analyte-containing solution.

24. The method of claim 1 wherein the analyte and the terminal portions of the second surface modifiers remain associated in the analyte-containing solution.

25. An affinity capture surface comprising a substrate surface having a plurality of first and second surface modifiers associated therewith, wherein:
the first and second surface modifiers render the affinity capture surface wettable and resistant to non-specific protein adsorption;
the second surface modifiers are capable of selectively retaining an analyte;
the first surface modifiers have the structure:
-A-L-X-Y₁; and
the second surface modifiers have the structure:
-A-L-X-Y₂-Z,
wherein each A is a terminal anchoring moiety associated with the substrate surface, L is a linker moiety, X is a cleavable moiety, Y₁ and Y₂ are protein adsorption resistant moieties and Z is an affinity capture moiety.

26. The affinity capture surface of claim 25 wherein:
A is —S—;
L is —(CH₂)ₘ—;
X is 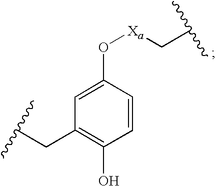
Y₁ is —(OCH₂CH₂)ₙOY₁ₐ;
Y₂ is —(OCH₂CH₂)ₚ—;
Xₐ is —C(═O)—, —C(═O)O—, —C(═O)NH—, —C(═O)S—, —SO₂—, —Si(CH₃)₂—, —Si(CH₂CH₃)₂—, —Si(CH(CH₃)₂—, —CH₂CH═CH— or —CH₂C₆H₄—;
Y₁ₐ is —H or —CH₃;
m is an integer from 2 to 16;
n is an integer from 3 to 7; and
p is an integer from 5 to 9.

27. The affinity capture surface of claim 26 wherein Xₐ is —C(═O)—, Y₁ₐ is —H, m is an integer from 4 to 10, n is 3 or 4, and p is an integer from 5 to 9.

28. The affinity capture surface of claim 25 wherein the substrate surface comprises metal.

29. The affinity capture surface of claim 28 wherein the substrate surface comprises gold.

30. The affinity capture surface of claim 25 wherein Z comprises a hapten or a ligand.

31. The method of claim 25 wherein Z comprises a reactive moiety capable of retaining a hapten or ligand.

32. A method for preparing the affinity capture surface of claim 25 wherein A is —S—, the method comprising contacting the substrate surface with a plurality of first and second thiols, wherein:
the first thiols have the structure:
HS-L-X-Y₁; and
the second thiols have the structure:
HS-L-X-Y₂-Z.

33. The method of claim 32 wherein the substrate surface comprises metal.

34. The method of claim 33 wherein the substrate surface comprises gold.

35. The method of claim 33 further comprising applying a positive potential to the substrate surface while contacting the substrate surface with the plurality of first and second thiols.

36. A method for preparing the affinity capture surface of claim 25 wherein A is —S—, the method comprising contacting the substrate surface with a plurality of first and second disulfides wherein:
the first disulfides have the structure:
Y₁-X-L-S—S-L-X-Y₁; and
the second disulfides have the structure:
Z-Y₁-X-L-S—S-L-X-Y₁-Z.

37. The method of claim 36 wherein the substrate surface comprises metal.

38. The method of claim 37 wherein the substrate surface comprises gold.

39. The method of claim 37 further comprising applying a positive potential to the substrate surface while contacting the substrate surface with the plurality of first and second disulfides.

40. A sample presentation device comprising the affinity capture surface of claim 25 and an adjacent surface-tension-directed transfer surface.

41. A sample presentation device comprising the affinity capture surface of claim 25 and an adjacent electrowetting-on-dielectric transfer surface.

42. The sample presentation device of claim 40 or claim 41 wherein the adjacent transfer surface is separated from the affinity capture surface.

43. The sample presentation device of claim 40 or 41 wherein the adjacent transfer surface is contiguous with the affinity capture surface.

44. The sample presentation device of claim 43 wherein the adjacent transfer surface is partially surrounded by the affinity capture surface.

45. The sample presentation device of claim 43 wherein the adjacent transfer surface is completely surrounded by the affinity capture surface.
